(19) United States
(12) Patent Application Publication
(10) Pub. No.: US 2009/0310154 A1
(43) Pub. Date: Dec. 17, 2009

(54) Chromatic Component Replacement

(75) Inventors: Jan Morovic, Essex (GB); Johan Lammens, Barcelona (ES); Michel Georges Encrenaz, Barcelona (ES)

Correspondence Address: HEWLETT-PACKARD COMPANY;Intellectual Property Administration, 3404 E. Harmony Road, Mail Stop 35, FORT COLLINS, CO, 80528, US

(73) Assignee: Hewlett-Parkard Development Company, L.P., Houston, TX (US)

(21) Appl. No.: 12/302,679

(22) PCT Filed: May 30, 2006
(86) PCT No.: PCT/EP2006/062692

§ 371 Date: Jul. 8, 2009

(51) Int. Cl. H04N 1/60; G09G 5/02

(52) U.S. Cl. 358/1.9; 345/590

(57) ABSTRACT

A color-separation LUT and/or algorithm method and apparatus preferably convert input device-color data to output device-colorants, for many color-presentation types—automatically and for arbitrary colorant-set. In one major aspect of the invention, a device-hue ring is defined along six straight edges of a cubical device-hue space (without segments ending at white and black). Preferably coordinates defined along the six segments parametrize the procedure and equipment, i. e. establish colorant indexing by those coordinates (and preferably device-hue). In a second major aspect, plural color transformations—having respective favorable and adverse characteristics—serve different portions of input color space; their outputs merge to combine favorable properties of the transforms. In a third, cusps of the colorant hue planes populate the output side of the hue ring. In a fourth, a colorant sampling technique (faster by several orders of magnitude than exhaustive sampling) canvasses the output space.

### RELATED APPLICATIONS

This application claims priority to, and is a US National Phase of, International Patent Application No. PCT/EP2006/062692, having title “CHROMATIC COMPONENT REPLACEMENT”, having been filed on 30 May 2006 and having PCT Publication No. WO2007/137621, commonly assigned herewith, and hereby incorporated by reference.

### FIELD OF THE INVENTION

The invention relates generally to incremental color printing and other means of color presentation—as in monitor screens and projectors—and more specifically to color separation that transforms input device-colors to an output colorant space typically having five or more colorants. For purposes of this document, except where contraindicated by context, the terms “colorant” and “ink” encompass dyes, transfer waxes, toners and other colorant substances, and the phosphors, lights etc. of monitors and projectors—as well as ink per se.

At the outset it will be helpful to confront an issue of nomenclature which is frequently confusing, in this area of color technology that is precisely at an interface between different colorant spaces that are interrelated. Such spaces may have different numbers of colorants—or may simply have different colorants.

In such situations the colorants (or “device colors”) in a color-information-source space are usually or often regarded as e. g. subtractive colorants, while some or all in a target or destination space are often or usually considered additive colorants. As will be understood, however, in some cases the reverse is true.

Further in these situations it often happens that some or all colorants of the destination space are considered complements and/or, in particular, combinations of some or all colorants making up the source space. In such circumstances commonly many workers in this field refer to physical colorant combinations as “secondaries”, as for example with the combinations of traditionally “subtractive” colorants cyan plus magenta (C+M), cyan plus yellow (C+Y) and magenta plus yellow (M+Y). These particular secondary combinations are said to “make” the traditionally additive colorants blue (B), green (G) and red (R) respectively.

When blue, green and red arise in a common space, however, most usually they are designated “primaries” and their combinations (B+G, B+R, G+R) are called “secondaries”. While this alone is enough to be confusing, what is now particularly awkward is the situation in which colorants of the two general types (primaries and secondaries)—and sometimes still others (tertiaries etc.)—actually coexist as physical colorants all available in one or another of the spaces.

For purposes of the present document, such coexisting colorant subsets most commonly occur in the target space and are regarded as “expanded” or “enhanced” etc. colorant sets. In hopes of minimizing awkwardness and confusion, we adopt this convention:

(1) We call all the actual physical individual colorants of a space (whether source or target) the “primaries” of that space—even though each of them can be made, or very nearly made, by combinations of two or more other colorants in that space or in a transform-linked space.

(2) We call simultaneous uses (particularly but not limited to overprintings) of two colorants “secondaries”—even though substantially the same color may exist as a single individual colorant, in that space or in a transform-linked space.

This document occasionally reminds the reader of this convention. For that purpose we shall refer to this convention as our “single-colorant-primary rule”.

Further complicating this topic is this unfortunate perceptual, or psycho-physical, fact that combinations of actual physical colorants that are most commonly additive (e. g. RGB) with actual physical colorants that are most commonly subtractive (e. g. CMY) do not at all follow the usual combinatorial behaviors of either group considered alone. Merely by way of example, red plus yellow (R+Y) does not produce orange as does yellow-plus-magenta plus yellow (CM+Y), but rather produces the identical original red. In view of such phenomena it is important that automated color transformations take into account what the actual results are—or, more practically, that such combinations should usually or almost always be prohibited.

### BACKGROUND

Printing or other color presentation with more than three chromatic output colorants (e. g. an output ink space or other colorant set having more than cyan, magenta, yellow and black—CMYK) requires choices about how the output colorant space (e. g. cyan, magenta, yellow, black, red, green, blue—CMYKRGB) is to be used when the input data are in RGB, CMYK or some other device-color space. Making such choices may seem simple, but it is not—in large part because the problem is underdetermined; that is, many (or infinite) possible output solutions exist for each input color specification in device-color space.

Indeed, due to divergent theories or preferences about ideal proportions for undercolor removal or “gray replacement”, this can be true even for the usual four output colorants. One problematic implication of these facts is that fine-gradation transitions between output colorants that are selected for very subtly different, nearby specifications in the input space may turn out to be not-at-all subtle jumps in the output space. Such discontinuities or disproportionalities are particularly troublesome in transitions between a primary that is typically used subtractively and one that is typically used additively—e. g., between yellow and red inks—since, as mentioned earlier, such colorants do not combine in at all the same familiar ways of subtractive or additive primaries alone.

Typical arrangements for making these choices involve some process performed manually by an engineer. Such processes are time consuming, and objectionably vary with the skill and technique of the engineer; and furthermore require manual rework for every new or revised ink set.

We believe it is important to focus upon device-space inputs, as a point of departure, rather than upon colorimetry. By colorimetry we mean perceptual-space inputs, and thus transformation from perceptual- to ink-space dimensions. Although perceptual or “human visible” criteria for color specification might seem a particularly logical choice, a major problem arises from such a starting point.

The problem is that many or most printing projects, and other color-presentation projects, begin with color specifications provided in the form of device-space inputs. Information important to buyers of printing services (or other people who wish documents printed) is irrecoverably lost in converting such inputs to perceptual parameters.

Some very advanced workers have undertaken to provide separations, based on device-space inputs, automatically—e.g. Van de Capelle and Van Bael, in published U. S. patent applications 2003/0002061 and 2003/0234943, respectively; and Huang and Nystrom in U.S. Pat. No. 6,956,672. While it is not intended to unduly criticize these impressive accomplishments, these innovations are believed to leave unresolved gaps in output gamut, or computational intensities that are intractable for real-time operation.

To summarize, achievement of uniformly excellent color separation for incremental printing continues to be impeded by the above-mentioned problems of disproportional transitions, excessive computation, or gamut inadequacies. Thus important aspects of the technology used in the field of the invention remain amenable to useful refinement.

### SUMMARY OF THE DISCLOSURE

The present invention introduces such refinement. In its preferred embodiments, the invention has several aspects or facets that can be used independently, although they are preferably employed together to optimize their benefits.

In preferred embodiments of its first major independent facet or aspect, the invention is a method for preparing to present specified input device-colors using an output colorant space. The method includes the step of formulating a lookup table or real-time computation algorithm, or both, to transform input device-color to an output colorant space.

The formulating step includes the substeps of defining plural color-space transformations for use in different portions of an input device-color space; and assembling the table or algorithm, or both, to blend the plural transformations. The method also includes the step of making the table or algorithm, or both, physically available in a nonvolatile medium for use in presenting the output colorant.

The foregoing may represent a description or definition of the first aspect or facet of the invention in its broadest or most general form. Even as couched in these broad terms, however, it can be seen that this facet of the invention importantly advances the art.

In particular, certain physical limitations of combinatorial color relationships militate against obtaining—through an automatically operated method—a single transformation that produces an optimum unitary gamut throughout an output device-colorant space. The nature of these limitations will be detailed in a later section of this document. We have discovered that this obstacle can be overcome by dividing the problem, and the gamut and color space, into two or more parts and solving them piecemeal as outlined above.

Although the first major aspect of the invention thus significantly advances the art, nevertheless to optimize enjoyment of its benefits preferably the invention is practiced in conjunction with certain additional features or characteristics. In particular, preferably the formulating step further includes forming the table or algorithm, or both, to remove substantially all gray from input device-colors before applying the transformations, and to replace the removed gray in the output colorant space thereafter.

A second basic preference is that the plural transformations comprise at least these two: a first transformation which yields an output colorant-space gamut that is relatively homogeneous internally, but relatively small and subject to concavities, and a second transformation which yields an output colorant-space gamut that is relatively larger and with minimal or no concavities, but subject to relative internal inhomogeneity. An additional part of this same basic preference is that the formulating step cause the table or algorithm, or both, to blend the transformations to form (1) a hybrid relatively larger gamut that is relatively homogeneous internally and with minimal concavities, and (2) output colorant-space color specifications of the hybrid gamut. As will be understood by people skilled in the field, the hybrid gamut combines the favorable attributes of both the individual gamuts.

If the second basic preference is observed, then it is further preferable that the formulating step further include these additional actions:

causing the table or algorithm, or both, to step a selection protocol around a hue ring of the input device-color space, to successively select device-color hues of that space;

aligning the first and second transformations, and thereby the output color specifications, with respect to hue; and

for each of said selected device-hues, processing the hue-aligned output color specifications to form a transformed color in output colorant space.

If these causing, aligning and processing steps are included, then a further nested preference is that the formulating step:

establish one of the transformations by locating a color of substantially maximum chroma for each hue along the hue ring, respectively; and

further include indexing the maximum-chroma colors by hue, to access the table or algorithm, or both.

If the above-mentioned “second basic preference” is observed, then there is yet a further preference if it happens that the relatively larger gamut, established by the first and second transformations, encompasses little or no output device-space volume surrounding at least one specific secondary color. (This happening, while perhaps counterintuitive, in fact is commonplace and somewhat to be expected.)

In this case preferably the plural transformations further include at least a third transformation which yields an output colorant-space gamut addition that encompasses output device-space volume including the at least one specific color. Also preferably the table or algorithm, or both, blend at least all three transformations to provide a relatively larger gamut that is substantially homogeneous internally and with minimal concavities, and encompasses output device-space volume including the at least one specific color.

In event this three-transform blending preference is observed, then it is still further preferable that the formulating step establish the third transformation by expanding the overall gamut toward darker colors. This preferred expansion is also toward the at least one specific color, based upon a normalized distance, in input device-space, between the input device-colors and the neutral axis.

One additional basic preference will be mentioned. Preferably the method includes these steps, with respect to at least multiple pixels in an image:

directing input device-space color specifications as inputs to the table or algorithm, or both;

reading output colorant-space values as outputs from the table or algorithm, or both; and

applying the output colorant-space values to rendition and other presentation-engine makeready stages, for presenting the colors.

From mention of these three steps it will be particularly clear that the first main facet of the invention is a practical and utilitarian procedure.

In preferred embodiments of a second of its facets or aspects, the invention is a system for presenting input device-colors using an output colorant space. The system includes a color presentation engine.

It also includes a driver. The driver in turn includes a lookup table or real-time computation algorithm to transform input device-color to an output colorant space.

The table or algorithm, or both, have been formulated by a process that includes the step of defining plural color transformations for use in different portions of the input device-color space. The formulation process also includes the step of assembling the table or algorithm, or both, in such a way as to blend the plural transformations.

The system also includes some means for directing input device-color specifications as inputs to the table or algorithm, or both. In addition the system includes some means for applying blended-transformation output colorant-space values—from the table or algorithm, or both—via rendition and other makeready stages, to the presentation engine.

The foregoing may represent a description or definition of the second aspect or facet of the invention in its broadest or most general form. Even as couched in these broad terms, however, it can be seen that this facet of the invention importantly advances the art.

In particular this second main, “system” aspect of the invention extends to the apparatus domain the method-related benefits, stated earlier, of subdividing the automatic generation of a multicolor separation by regions within the input device-color space. As noted above, the physical character of color crosscombinations—as between colorants that are usually subtractive and colorants that are usually additive—obstructs a unitary automatic solution to the general multicolor-separation problem. Such obstruction is circumvented by an automatic system that differently transforms the colors of different device-color subspaces, and then merges the two solutions to cover all or most of the overall gamut.

Although the second major aspect of the invention thus significantly advances the art, nevertheless to optimize enjoyment of its benefits preferably the invention is practiced in conjunction with certain additional features or characteristics. In particular, preferably the process mentioned immediately above—the one used to formulate the table or algorithm, or both—further comprises the step of removing substantially all gray from input device-colors before applying the transformations, and replacing the removed gray in the output colorant space thereafter.

Another preference applies if the plural transformations include at least two transformations that respectively yield output colorant-space gamuts that have respective colorimetric deficiencies. In this event it is preferred that the formulating step cause the table or algorithm, or both, to blend the transformations to provide a single output colorant-space gamut that is substantially free of the deficiencies.

An analogous preference, but stated more specifically than the one discussed immediately above, applies if the plural transformations include at least one transformation that yields an output gamut that is substantially homogeneous internally, but relatively small and subject to concavities; and another that yields an output colorant-space gamut that is relatively larger and with minimal or no concavities, but subject to relative internal inhomogeneity. In this case preferably the formulating step causes the table or algorithm, or both, to blend the transformations to provide a relatively larger gamut that is substantially homogeneous internally and with minimal concavities.

In preferred embodiments of a third of its facets or aspects, the invention is a method of presenting input device-colors, but using output device-colorants. The method includes performance, or an abbreviated procedure yielding the same results as performance, of these steps:

establishing coordinates along a hue ring, and

with each coordinate, associating a respective output device-colorant specification.

The result of these steps is that the associated output device-colorants are indexed by the hue-ring coordinates, for subsequent use in a transformation that maps the coordinates to corresponding output device-colorant specification. The method also includes presenting colors based upon the indexed output device-colorants.

The foregoing may represent a description or definition of the third aspect or facet of the invention in its broadest or most general form. Even as couched in these broad terms, however, it can be seen that this facet of the invention importantly advances the art.

In particular, the hue ring provides both structure and sequence to the selection of device-color points for transformation. The hue-coordinate parameter becomes the organizing core of the separation; it is a particularly useful choice because hue is dominant in the human discrimination of color. Interestingly this skeleton of the transform includes no point along the neutral axis.

In short, the hue ring serves to systematize the overall process. Use of hue in this way is advantageous also (as will be seen in a later section of this document) because it introduces an essentially cost-free opportunity to hue-emulate other color-presentation methods and systems.

Although the third major aspect of the invention thus significantly advances the art, nevertheless to optimize enjoyment of its benefits preferably the invention is practiced in conjunction with certain additional features or characteristics. In particular, one basic preference is that the method further include the step of, at each coordinate, determining or establishing a respective input device-hue. As a result of this step, the associated output device-colorants are indexed by said input device-hues, too, for the previously mentioned subsequent use.

If this basic preference is observed, then further preferably the associating step includes associating an output device-colorant that has maximum chroma at the determined or established input device-hue. If this further preference, too, is satisfied, then it is still further preferred that the input device-hues are native to a color-presentation device which the transformation, with its presenting step, thereby emulates.

To say the same thing in a slightly different way: the previously mentioned transformation, and its accompanying presenting step, considered together emulate operation of a certain color-presentation device—ideally some specific make and model of e. g. a printer, monitor, or projector, or alternatively a generic device of one of these types. Our preference, here, is that the input device-hues be native to that presentation device.

Here this last sentence is to be understood in a rather specific way. It means, for example, that the presentation device has (1) colorant-presenting hardware, and (2) customary, commonly used various-hued colorants presented by the hardware, and (3) various electromechanical settings that modulate the presentation of the colorants by the hardware. It also means that the device-hues mentioned are the ordinarily expected output hues from this complex of equipment, colorants and settings, as a package. Thus they are the hue part of a conventional, commercially established and even traditional color appearance of images formed by the referenced presentation device. Our reason for elaborating this concept to such an extent, here, is that the presentation device in question is usually itself capable of emulating, in turn, traditional or customary hues of yet other presentation devices. In order for the concept of “native” hue emulation to have some definite, stable meaning, we mean to exclude such second-generation hue emulation. Thus, to avoid confusion, the native hues that are emulated by our invention are not hues of a device that is perhaps in turn emulating some other device, but rather only of the one specific presentation device mentioned.

Now, if the preference under discussion here is in use, i. e. if input device-hues used in the parametrizing hue ring are in fact native to a color-presentation device which the transformation emulates, then we have yet another nested preference. Specifically, we prefer that those input device-hues be one of these hue sets:

incremental-printing device-hues, including but not limited to inkjet, bubble-jet, wax-transfer, and laser-printer colorant spaces;

offset-lithographic, gravure, or flexographic printing device-hues;

display device-hues, including but not limited to those used in computer monitors, television sets and other video screens; and

projection device-hues, including but not limited to those used in laser- and conventional arc-lamp-projection technologies.

The emulation obtained in this very easy and economical way is limited in that it does not mimic the full color-appearance, but only the native hues, of the reference device.

Yet another basic preference is that the method steps further include defining a gamut boundary of the output device-colorants, by these steps:

choosing contone vectors representative of substantially all the output device-colorants, as used throughout their colorant space;

operating a presenter model to calculate reflectance spectra of all the chosen vectors;

operating a perceptual color model to calculate perceptual parameters, from the spectra, for all the chosen vectors; and

operating a gamut boundary description algorithm to define, from the perceptual parameters, the output-space gamut boundary.

For purposes of this document, including the claims, references to “reflectance spectra” and the like shall be understood (unless excluded by the context) to encompass colorimetries, particularly as appropriate for emissive, additive-color devices. For such devices, there is less need for reflectance spectra and greater difficulty with measuring them in practice.

If these steps are included, to thereby define the output-colorant gamut boundary, then we further prefer that the choosing step include paired-surface sequential sampling. In this case, the paired-surface sequential sampling is used to establish colors substantially throughout the entire output colorant space—particularly including dark colors below the cusps of the output-space gamut.

Another basic preference is that the abbreviated procedure include referring to a lookup table previously formulated, by the enumerated steps, to yield the same results.

All of the foregoing operational principles and advantages of the present invention will be more fully appreciated upon consideration of the following detailed description, with reference to the appended drawings, of which:

### BRIEF DESCRIPTION OF THE DRAWINGS

FIG. 1 is a block diagram or flow chart, highly schematic, of an overview of the present invention in the overall context of a printing or other color-presentation system and method;

FIG. 2 is a diagram of the rectangular device cyan-magenta-yellow (dCMY) cubic color-space, including vertices representing so-called “secondaries” CM, CY and MY—as well as the white-point 0 (zero) and black-point (CMY) vertices that define the neutral (nonchromatic color) axis—and also showing the hue ring 21-26 defined along six straight-line edges of the color-space cube 20;

FIG. 3 is a pair of graphical illustrations including, in the “A” view, an elementary hue-ring lookup table (LUT) in the form of a graph, with hue coordinates (corresponding to the six hue-ring segments 21-26 mentioned above) along the axis of abscissas—in units of eight bits (0 through 255) for each segment—and sixteen-bit contone vectors along the axis of ordinates; and, in the “B” view, a scatter graph of a corresponding gamut in the CIELAB space, as projected into the a*b* plane and particularly revealing undesirable strong concavities in the gamut periphery;

FIG. 4 is a flow chart, highly schematic, of a theoretical gamut computation method;

FIG. 5 is a diagram relating the FIG. 2 device-colorant cube (left) to so-called “cusps” of hue planes in perceptual CIELAB color space (right);

FIG. 6 is a triple illustration of gamut-calculation details including, in the “A” view, a graph of contones very generally analogous to FIG. 3A but instead corresponding to theoretical gamut cusps for all hues (and having, along the abscissa, 360-degree hue angle as in the CIECAM02-space, or equivalently as in the classical Munsell-space, rather than hue-ring coordinates); and in the “B” view a flow chart of maximum-chroma calculation for the dCMY hue ring; and in the “C” view another LUT graph like FIG. 3A but with improved contone profiles;

FIG. 7 is a scatter graph like FIG. 3B but of a gamut corresponding to the FIG. 6C LUT rather than the FIG. 3A LUT, and particularly revealing undesirable internal inhomogeneity—including large gaps near the hues of the secondaries (iRGB);

FIG. 8 is a graph of typical blending-point values around the hue ring, in the blended-transform aspects of the invention;

FIG. 9 is a color-space cube diagram like FIG. 2 but more particularly relating the basic cube geometry to several parameters of the blended-transform feature of the invention—including triangular-cusp location, maximum-cusp location, blending-point location p, scale factors α and β, and gray component κ;

FIG. 10 is a scatter graph like FIGS. 3B and 7 but of a much-improved gamut having reduced inhomogeneity and fewer gaps;

FIG. 11 is a flow chart of procedures for hue-alignment of plural color transformations and their corresponding LUT contributions;

FIG. 12 is a resulting LUT, based on the FIG. 11 procedures, for triangular contones hue-aligned with corresponding PSS-cusp contones;

FIG. 13 is a graph of lightness vs. hue-ring index for an additional, so-called “cusp to black” (CTB) gamut extension that corrects problems of missing secondaries in the basic blended-transform aspects of the invention;

FIG. 14 is a LUT of CTB cusp contone vectors in the FIG. 13 gamut extension;

FIG. 15 is a color-space cube diagram like FIGS. 2 and 9 but also showing an additional parameter used in the CTB extension—namely a normalized distance dₙ from the PSS maximum cusp toward the CMY black point;

FIG. 16 is a set of two like diagrams, but defining several additional parameters of the mathematical formulation—particularly, colorant-space points of interest in the calculations, including the input point, its chromatic component, and two other points corresponding to the input: one on the neutral axis, and the other on the triangular hue-plane top surface—plus four auxiliary graphs demonstrating lines of constant value of certain parameters, within each hue plane; more specifically, the upper-left-hand “A” view is one of the two cube diagrams, particularly representing the first transform-blending form of our procedure; the upper-right-hand “D” view is the other of the cube diagrams, particularly representing the second transform-blending form (featuring the CTB addition to gamut volume in lower, darker colors near the additive primaries); the two lower-left-hand “B” and “C” views are respectively iso-α and iso-κ nomographs (α and κ being respectively the first scale factor and the gray component as before); and the two lower-right-hand “E” and “F” views are analogous iso-β and iso-dₙ nomographs (β being the second scale factor and dₙ the normalized distance, also as before);

FIG. 17 is a set of three graphs of gamut increase in respective different hue planes, due to the CTB addition, at respective hue angles 30, 160 and 310 degrees—in the “A”, “B” and “C” views respectively; and

FIG. 18 is a set of three theoretical gamuts for seven-ink systems analyzed by, respectively, three different printer models: additive, in the “A” view; Kubelka-Munk in the “B” view; and Neugebauer in the “C” view.

### DETAILED DESCRIPTION OF PREFERRED EMBODIMENTS

THE OVERALL ROLE OF CCR IN MULTICOLOR SEPARATIONS—Preferred embodiments of the present “chromatic color replacement” (CCR) invention enable the making of color-separation choices automatically by computation, and for an arbitrary, expanded ink set—taking into account the behavior of a printer or other colorant-presentation device and the responses of a human viewer. Having the ability to compute separations on the basis of modeling the color-presentation device, colorants, and human perception automates optimization of printing performance for any combination of colorant that can be presented, and presentation medium, and for doing so on-the-fly.

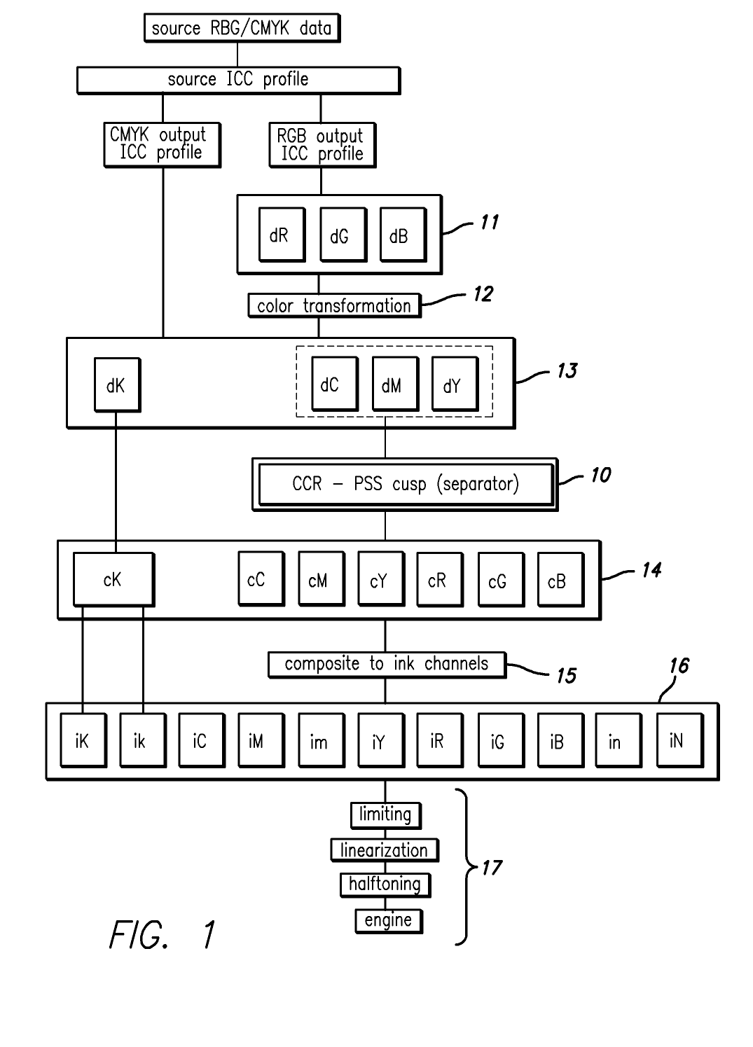

Preferred forms of this CCR invention 10 (FIG. 1) replace the chromatic colorants of CMYK inputs 13—or portions of those inputs—with CMYK secondaries and other colorants. Those other colorants are expressly specified by an output-space colorant set—which can be, as noted above, substantially arbitrary.

These embodiments operate from device-color (rather than perceptual-space) inputs 13, and as will be seen provide a relatively large, convex gamut with good internal homogeneity—to minimize contouring and other symptoms of disproportional transition. A preferred embodiment also encompasses, within the gamut, all CMYK secondaries—particularly including the darker gamut regions between the cusps and the black point.

For purposes of this document the word “cusp” means, within each plane of constant hue, the point of maximum chroma. In other words for each conventional hue leaf the cusp is the point farthest from the neutral (white-to-black) axis. As is well known, such points are not all at the same lightness; i. e. the locus of cusps is a figure whose peripheral edge has very irregular vertical variation.

Thus the function 10 of CCR fits into the sequence of multicolor separation functions following generation 12 of the most-customary conventional device-colors 13—namely, device-space cyan, magenta, yellow and black, herein abbreviated dC, dM, dY and dK. These parameters 13 are often but not necessarily derived from scanner-output or video signals 11, which are usually device-red, -green and -blue, analogously abbreviated dR, dG and dB.

Throughout this document the prefix “d” indicates “device-space” colors. A prefix “c” denominates so-called “composite channel” colors 14; and a prefix “i” flags “ink”-space (or “ink set”) colors 15—or output colorants other than inks.

The composite channels 14 are simply expansions of the chromatic colors among the input device-space colors 13. In these expansions the chromatic input primaries dC, dM, dY (subtractive primaries) are augmented by, most commonly, all or some of the usual additive primary colors R, G B. This particular enlarged composite-space, however, is only exemplary of a great many composite spaces now used or proposed.

Such spaces include CMYKB, CMYKO (with orange), and some that make use of entirely new ink formulations, as well as others that even omit one or more of the basic C, M and Y. Our invention is capable of advantageous use in generating separations for any and all of such composite channels 14.

The composite channels 14 may undergo two kinds of changes in forming 15 the final colorant-space or contone colorant channels 16. One of these is reinsertion of black or gray components dK that were isolated and passed through or around the CCR stage 10.

Another kind of change is a simple splitting or subdividing of the composite-channel colors cM, cG etc. into concentrated and dilute forms of the same colors or colorants, for instance iM and im, iG and ig etc.—where the capital letters “M” and “G” represent the concentrated forms and the lower-case letters “m” and “g” represent the dilute forms. It is nowadays well recognized that dilute colorants have a very useful place in incremental printing for generating relatively subtle color gradations.

In particular the capital letter “N” represents the concentrated form of an “Nth” colorant (colorant number “N”) in the output ink set, and the lower-case letter “n” represents the dilute form of the same (“nth”) colorant. Thus the ink-space dimensions “iN” and “in” expressly embody the arbitrary and expansible character of the permissible ink sets.

Dilute colorants are now important particularly but not only in highlight regions, e. g. washes or other mixtures of chromatic colorant with white or with light grays. While these colorants do provide much finer gradations in such regions, they especially yield much lower granularity than can be achieved by, for example, reversing undercolor removal with the standard CMYK colors.

While the chromatic components of the input device-colors 13 are transformed by CCR 10 to form the composite channels 14, the nonchromatic component (gray) is passed through substantially unchanged to the contone ink (or other colorant) space 16. Following generation of the contone ink channels iC, iM, . . . iK come three further steps 17 (colorant limiting, linearization if used, and halftoning) that are generally conventional, and finally direction of the colorant output signals to a colorant-presentation engine 18.

The invention allows, in a novel way, relation of device-space characteristics directly to colorant-space characteristics (e. g. CMY device-primaries can be mapped directly onto CMY composite ink channels). It also enables explicit tracking of transitions; i. e., transitions in the device-space can be directly mapped to corresponding transitions in the colorant space.

HUE-RING PARAMETRIZATION OF THE COLOR SEPARATION—Preferred embodiments of CCR do not determine CMYRGB (and thereby CMYKRGB) outputs based on CMY input properties alone. CCR invokes an additional intermediate or connecting parameter to help organize, constrain and thus systematize the overall process and mechanics.

As in parametric equations and parametric spaces more generally, the connecting parameter (in this case the hue along a so-called “hue ring”) is employed to parametrize the entire regime. Preferred embodiments of the invention advantageously include a parametrization of the separation via a hue-ring lookup table (LUT), or if sufficiently rapid computation is available an equivalent hue-ring algorithm.

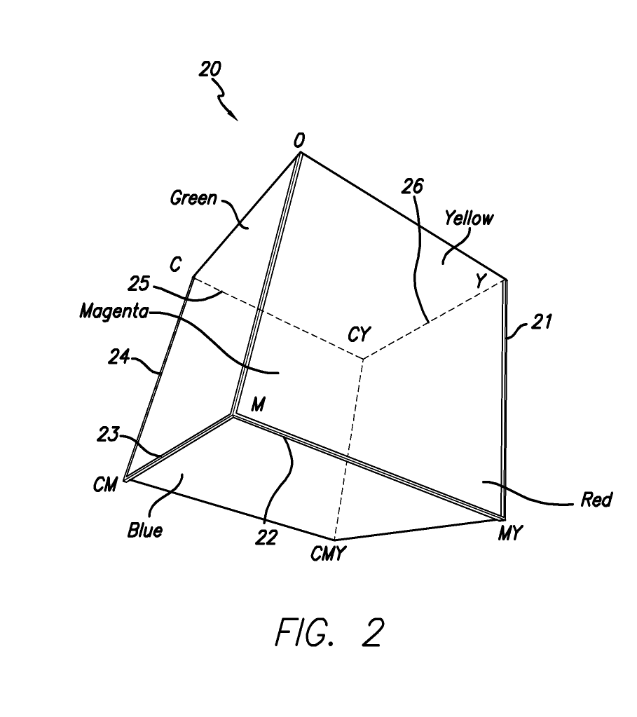

The hue ring here is a compound line in CMY space which circumnavigates a device-hue cube 20 (FIG. 2) by passing along its six straight-line edges 21, 22, . . . 25, 26, from primary to primary via the secondaries, and then back to the starting point, e. g. along the path Y-R-M-B-C-G-Y. Every other vertex is a CMY primary, the intervening alternate vertices being the secondaries.

These “secondaries” CM=B, CY=G and MY=R are properly so-called in the device-color input environment, where only three chromatic colorants exist. (As noted at the beginning of this document, nomenclature is more awkward for the output-colorant space, where the additional hues B, G, R occur as discrete physical colorants. According to our single-colorant-primary rule, we denominate such colorants “primaries”.)

Each point along the hue ring has one of the CMY coordinate segments at 100%, another at 0% and the third at an arbitrary value. The hue ring as used herein does not pass along any of the six other straight-line edges of the hue cube 20—i. e. those edges 0-M, 0-C, 0-Y at the top and CMY-CY, CMY-MY, CMY-CM at the bottom that respectively meet the neutral points 0 (white), CMY (black).

Thus the “hue ring” concept used in this document is somewhat more specific than the more-commonly seen “Munsell's hue ring”, or “hue circle” or “hue-ring plane”. These latter three concepts relate to perceptual color characterizations.

On one hand, hues along the hue ring herein therefore should not be confused with the more general hue variable as it is considered in the input and output device-spaces, or especially in perceptual spaces. In operation the separation-constructing process steps along the hue ring, as it moves selecting hues for transformation.

On the other hand, the hue ring may be conceptualized as an abstraction, having input device-color-space coordinates and output device-colorants, but without necessarily specifying at the outset what the input space is. As already seen in the foregoing “Summary” section of this document, just such a dimensional ambiguity can be put to distinct and valuable use, in some forms of the invention.

In an eight-bit binary system of color specification, the number of such discrete nonzero device-space CMY (dCMY) “hue” values or coordinates (dh) that can be traced out, along the six segments of the hue ring as defined above, is 6(2⁸−1)=6(256−1)=1,530. For each of these 1,530 device-hue coordinates dh, an output n-channel color vector is specified.

Output color vectors for planes of constant dh are then interpolated, or “scaled”, or “transformed”, as detailed below. Planes in which such a transformation occurs are defined by a dCMY vector, within the range of dCMY=[0,0,0] to dCMY=[255,255,255], and a maximum-chroma hue-ring color (i. e. the cusp).

THE BASIC CCR ALGORITHM, WITH ELEMENTARY OUTPUT-SPACE “POPULATION” OF THE HUE RING—For the following statement of the scaling, the device-hue dh will serve as an index into the lookup table (LUT) to be constructed. The index dh addresses an entry in the hue ring LUT that contains an n-channel output vector—the cusp vector. These further variables are hereby defined:
dCMY=the input;
α=a first scale factor—which addresses a dimension, in planes of constant dh, defined by the white-to-cusp vector;
κ=the gray component of dCMY, addressing another dimension in the same planes (note this is Greek kappa κ, not K or k).
   Now with these definitions, the transformation is:
   1. κ=min(dC,dM,dY)
   2. ∀ X∈{dC,dM,dY}: X′=X−κ
   3. α=max(dC′,dM′,dY′)/255
   4. ∀ X′∈{dC′,dM′,dY′}: X″=X′/α
   5. Two nonzero X″s determine which of the six segments of the hue ring contains dCMY
   6. The smaller of two nonzero X″s determines the index dh in the segment
   7. The index dh addresses a particular entry in the hue ring LUT that contains an n-channel output vector—the cusp vector.
   8. Scale each of the cusp vector's members by multiplying it by α.
   9. Add κ back into the C, M, and Y members of each scaled cusp vector.
   10. Clip each member of the resulting vectors to the 0-255 range.

In this document, references to “255” arise from use of eight-bit encodings. These, and other particular numerical values referring to standard eight-bit-per-channel usages, are just by way of example. Generalizations to other encodings such as floating point in [0,1] or integral sixteen bits per channel are within the scope of certain of the appended claims, and are straightforward.

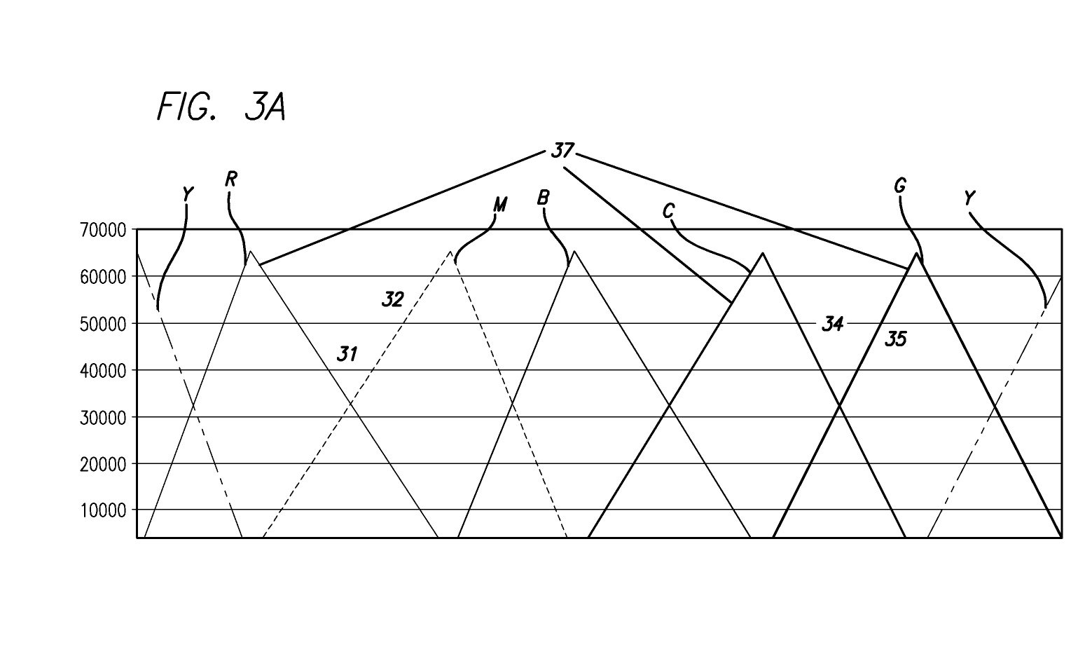

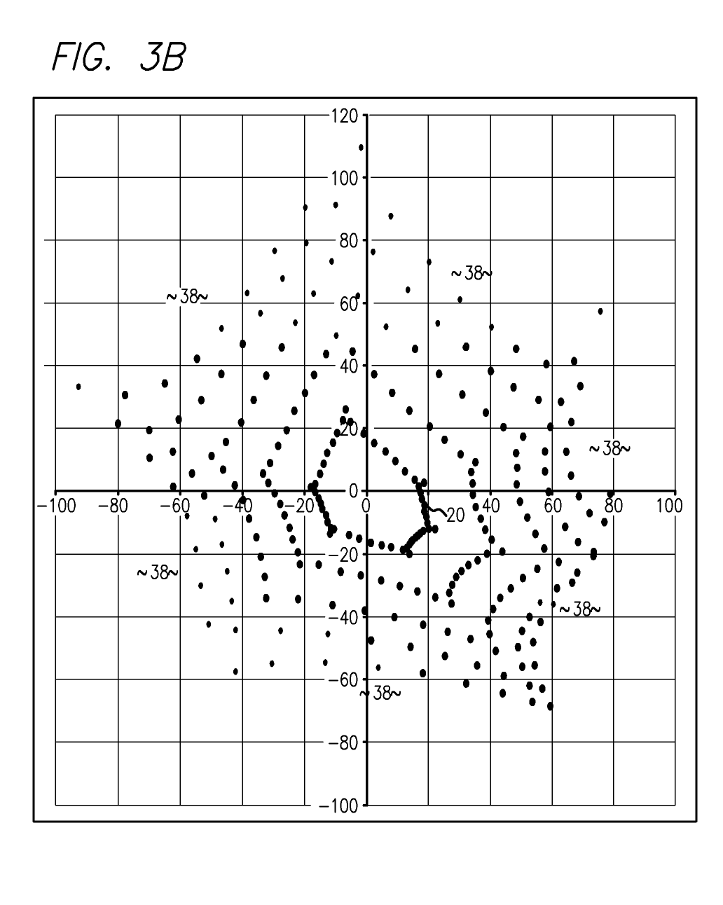

Given the above programmable separation algorithm, a critical step is to populate its hue ring LUT appropriately. In one very simple (perhaps the most intuitive) way of populating the hue ring, each colorant e. g. ink 32, 35 (FIG. 3A) ramps up while the preceding colorant 31, 34—in hue terms—ramps down. This simple model, when graphed, appears as a set of triangles 37.

Unfortunately this protocol for populating the hue ring produces a gamut that is very undesirable because of strong peripheral concavities 38 (FIG. 3B), which correspond to very irregular maximum-chroma levels for different hues. Besides this erraticism as such, the concave portions of its periphery are pinched, on an absolute chroma basis—meaning that tones at hues where the concavities arise are muddy and dull.

Needless to say, these are very unappealing traits for a printer output. The concavities between adjacent CMYRGB primaries (as so denoted according to our single-colorant-primary rule) are real desaturations in colorants—due to the physical combining properties of these particular colorant pairs—not merely artifacts of the arithmetic or of the mapping.

FITTING AN EXPANSIVE, CONVEX GAMUT TO THE HUE RING—Approaching the situation from the opposite end, however, it is possible to select inks (more generally, colorants) for an ink-set that are capable of very sharp and bright colors, and correspond to a gamut that is expansive—i. e. convex and relatively large. Using these convex-gamut output ink-space tones, and fitting them to the hue-ring LUT to exploit the systematic control provided by the previously introduced hue-ring parametrization, a much improved result emerges.

It will be understood that the present invention is not directed to selection, per se, of especially desirable output ink-sets. Rather to the contrary, as suggested earlier, the invention enables ink-sets to be selected separately from the conceptualization of this invention—whether e. g. arbitrarily, at the discretion of color scientists or ink chemists, or within the expertise of printing-industry professionals whose preferences have evolved through tradition and through their own individual trial-and-error experience.

The focus here is instead upon the fitting of the ink-set to the hue-ring algorithm or LUT. Hence little attention is devoted here to specification or selection of any particular ink-set, and instead this discussion moves on to a procedure for adapting the invention, and any particular preselected ink-set, to each other. It is assumed now that a particular ink-set has been designed, devised and or otherwise assembled—and that this ink-set has been selected for integration into color separation according to the invention.

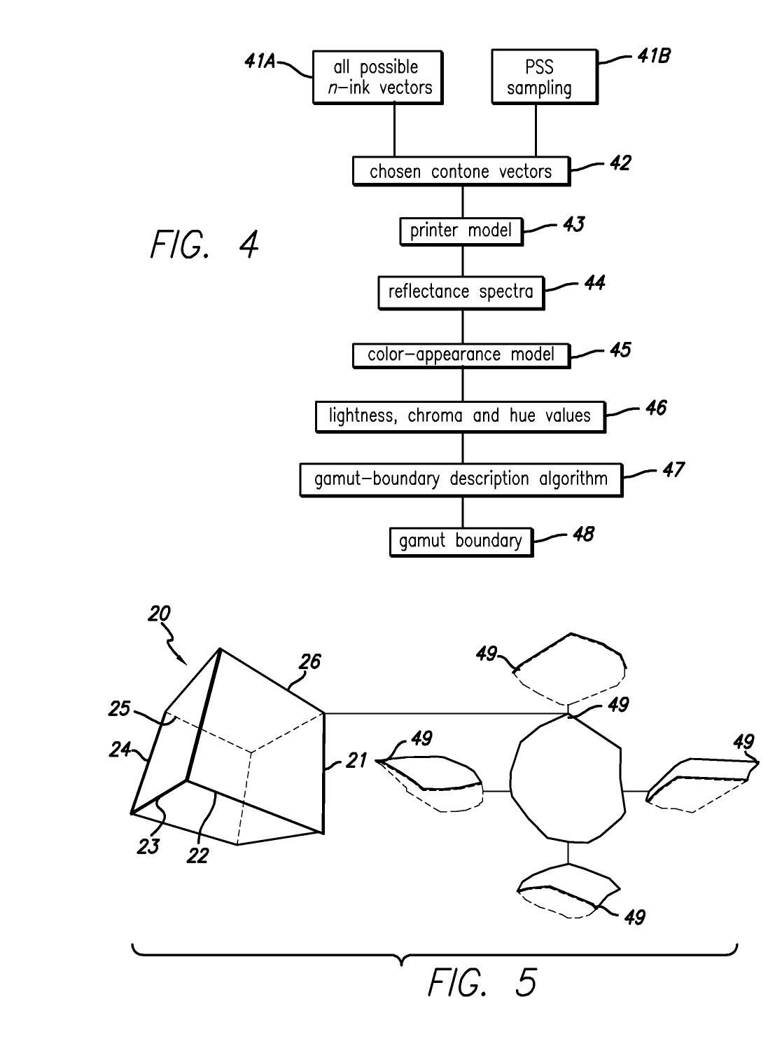

This approach to establishing LUT or algorithm entries begins by computing the theoretical gamut of the given ink-set. That computation is a four-step process, starting with selection 41 (FIG. 4) of a set of color vectors that are accurately representative of the entire ink-set.

In purest principle this first step can take either of two forms: (a) an actual comprehensive canvass 41A of the entire output ink-space, based on uniform sampling of all the inks and their patch-wise or ramp-wise intensities, and with a reasonable number of samples per ink; or (b) a substitute procedure 41B that assembles only a much more selective sample. The number of samples in the two sets differs monumentally—by, typically, some three to ten orders of magnitude—and the full canvass 41A is essentially prohibitive in computation times ranging from days to many years.

Fortunately the substitute 41B, known as “paired-surface sequential” sampling, produces substantially the same eventual gamut calculation. In consequence as a practical matter ordinarily only method 41B should be considered. It will be detailed in a later section of this document. The procedure 41B, then, produces a chosen set 42 of contone-ink vectors.

Second, these in turn are applied to a so-called “printer model” 43, which is a program that simulates actually:
(a) printing out the chosen contone vectors as ink-sample patches onto paper or other specified printing medium—and further
(b) generation of reflectance spectra 44 (measurements of reflected energy as a function of wavelength) for the print-simulation patches.
   This first step of the procedure is purely objective, or in other words involves exclusively physical phenomena measurable by calibrated photosensitive optical apparatus such as spectrometers.

Third, however, the simulated spectra 44 are directed to a perceptual color-space model 45 that simulates the response 46 of the human visual system to the spectral patterns represented in the spectra 44. That is, the perceptual model 45 produces a three-dimensional set of color signals, or parameters, representing a human viewer's visual experience upon examining the equivalent reflectance spectra.

Fourth, these color signals 46 next enter a gamut-boundary-description algorithm 47, which generates a color-space model 48 of the gamut boundary—or, speaking more generally, of the gamut. In particular this algorithm locates the colors of maximum chroma (i. e. the cusps) at each hue.

A line joining those cusps 49 (FIG. 5) corresponds directly, as may now be recalled, to the output-cusp color coordinates of the dCMY cube “hue ring” that is constructed along the edges of the hue cube 20. Consequently the output contone values of the final stage 48 are dimensionally compatible with LUT (or algorithm) entries addressed by the index dh.

In particular this algorithm takes the set of colors whose color gamut is to be described and either chooses a subset of these colors or generates new color coordinates from the set that allow for its boundary to be defined in color space. The resulting colors are then referred to as gamut boundary colors, which, together with a method of forming a surface on their basis (e. g. triangulation, locally-bilinear functions, etc.), then result in a description of the gamut boundary.

Examples of methods for choosing gamut boundary colors are: (a) to subdivide color space in terms of hue and lightness and then to select that color in each hue-lightness interval that has maximum chroma; (b) to subdivide color space in terms of spherical coordinates with the origin half-way up the lightness axis and then to choose vertices of maximum radius in each spherical interval; (c) to compute the convex hull of the colors whose gamut is to be described.

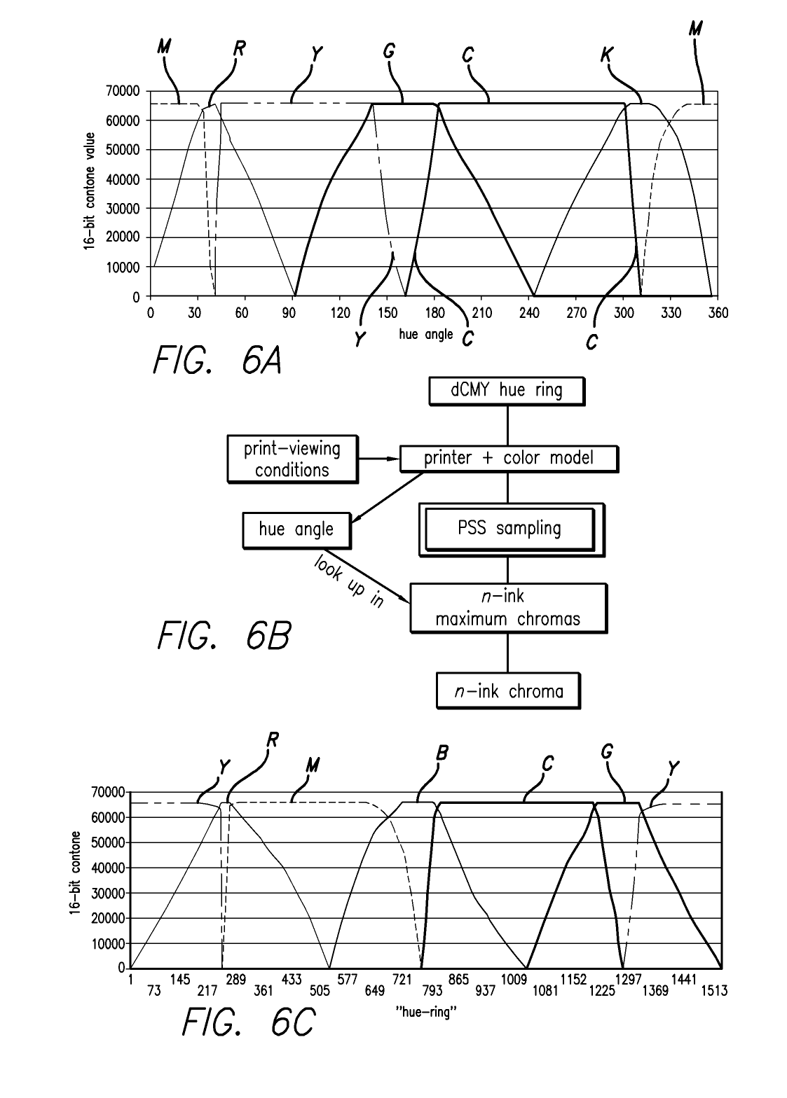

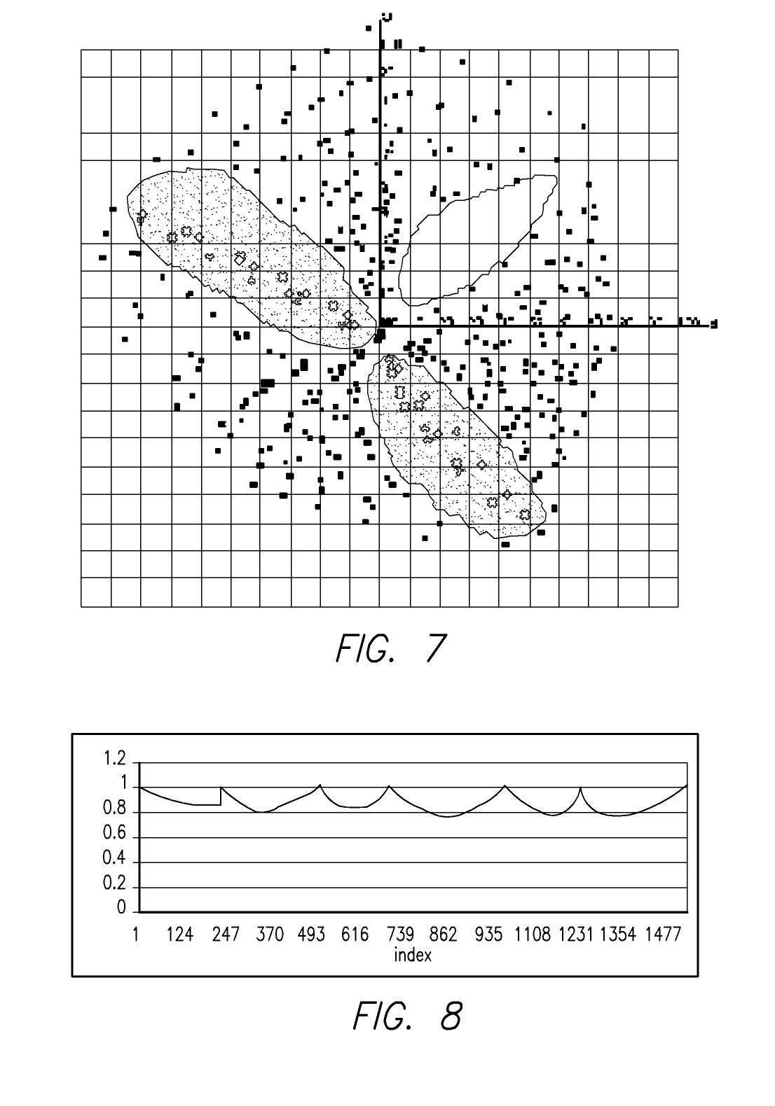

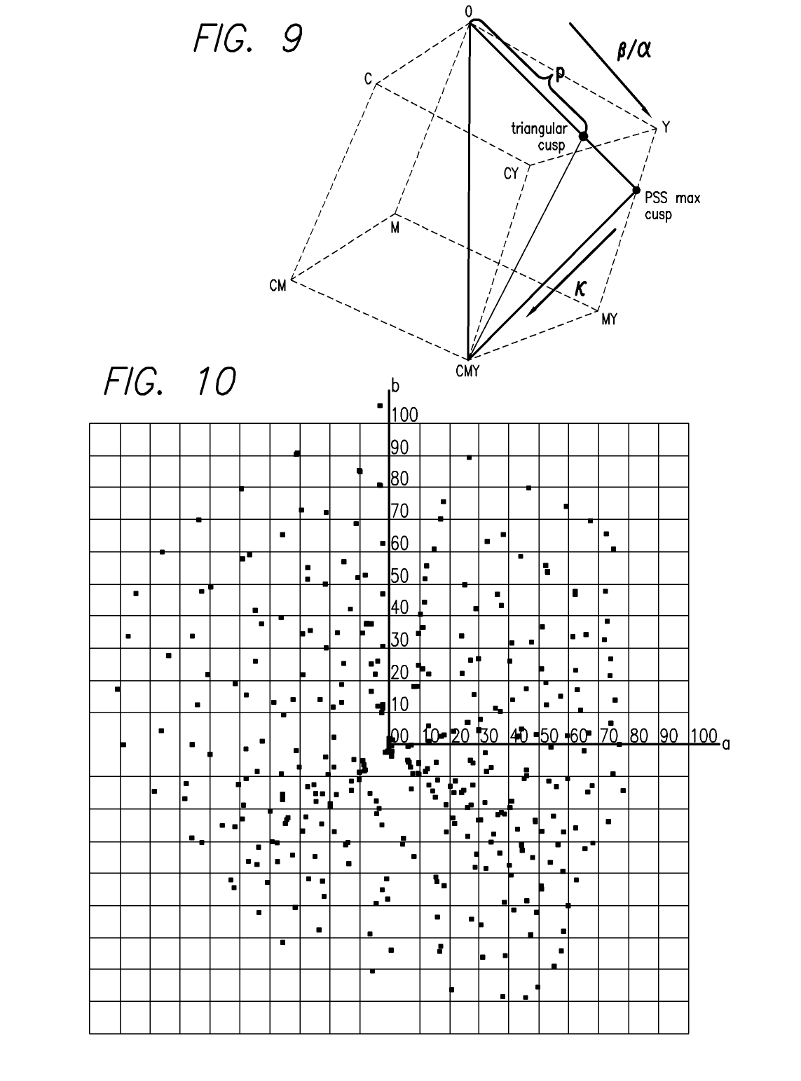

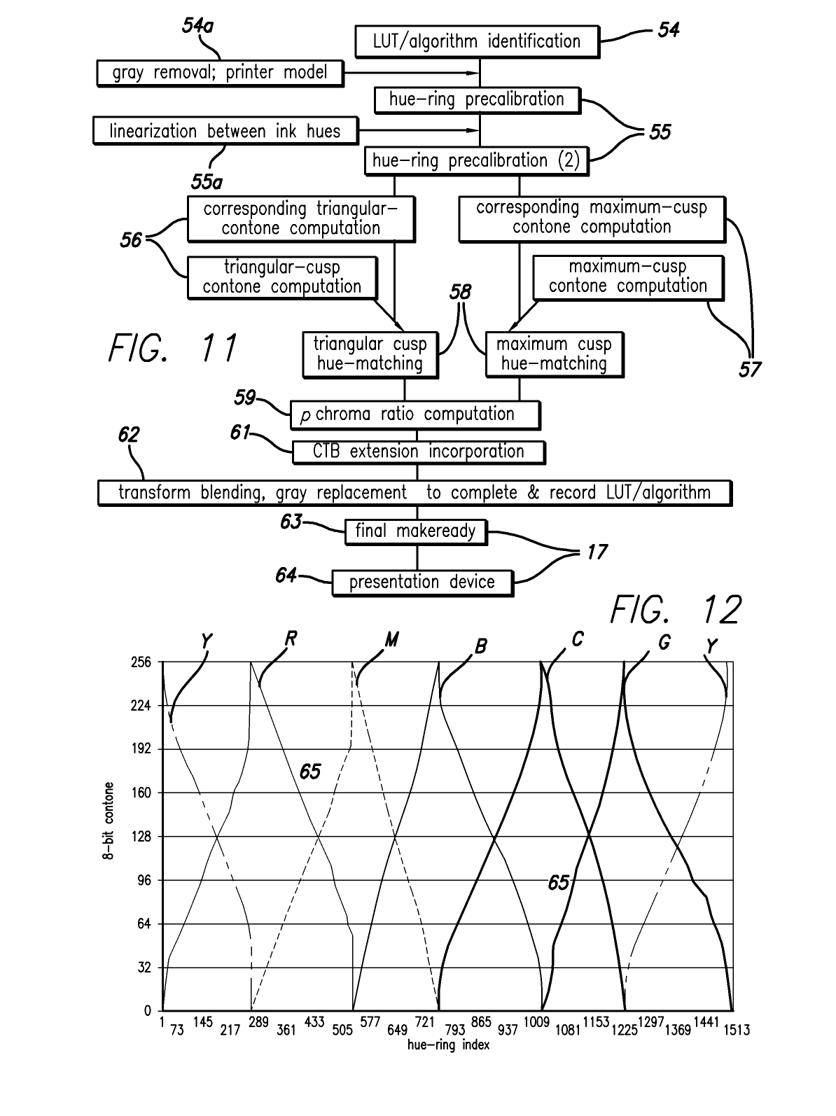

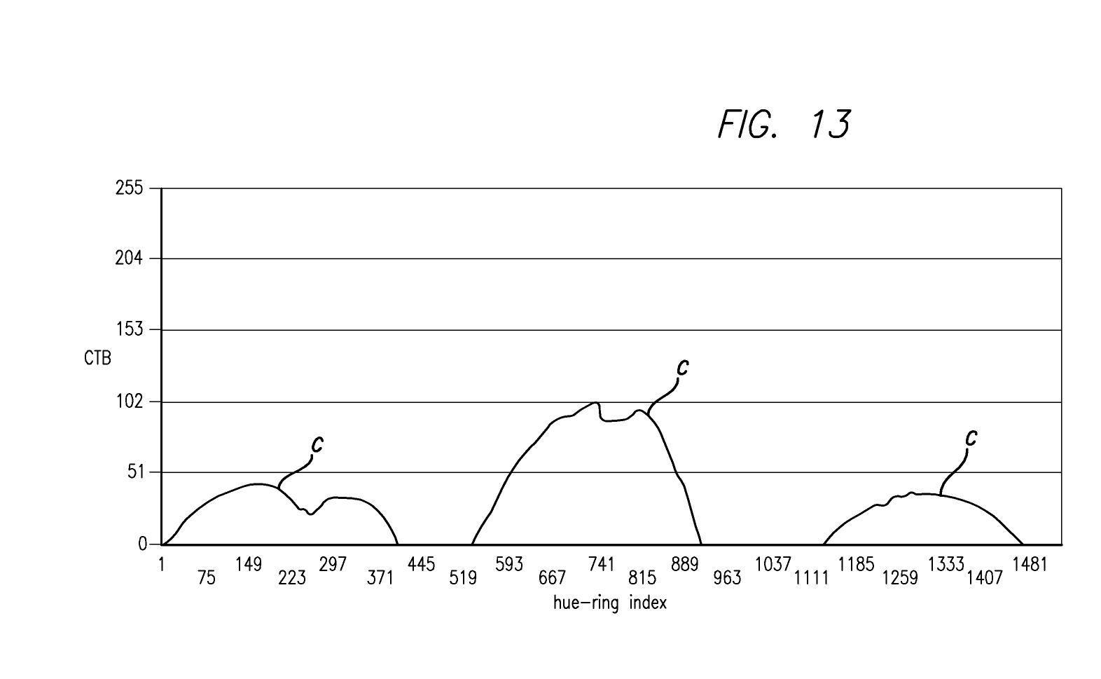

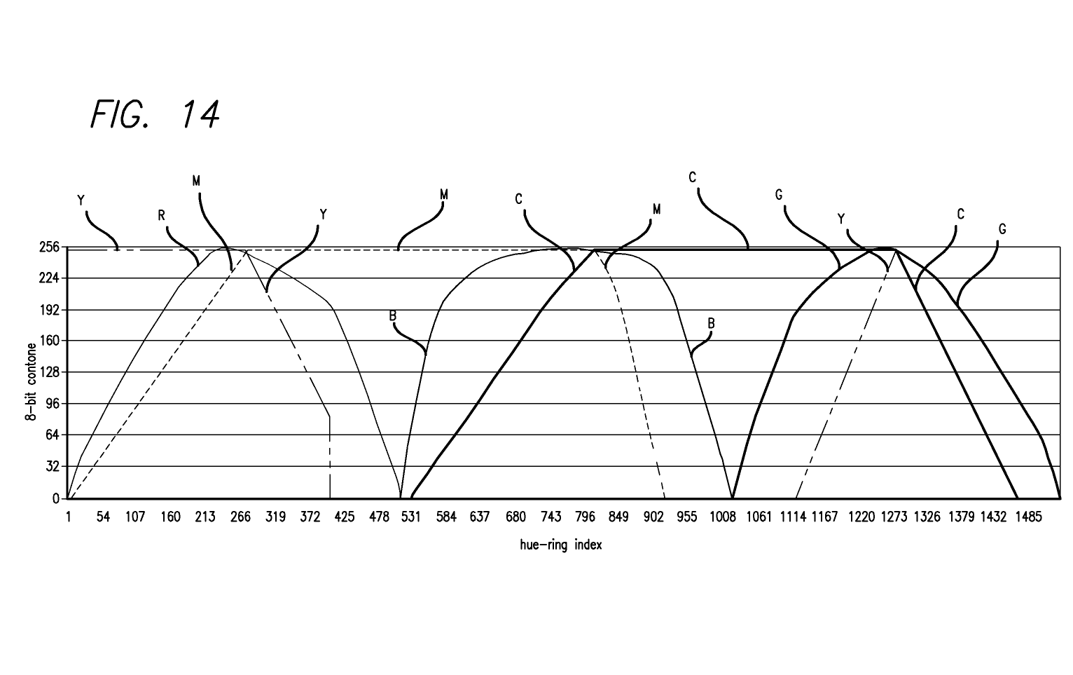

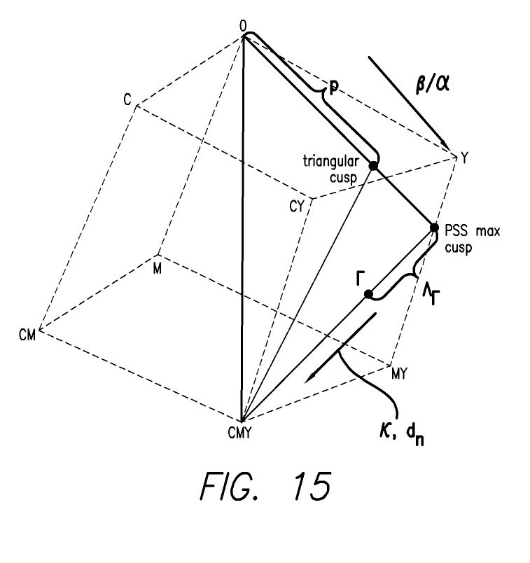

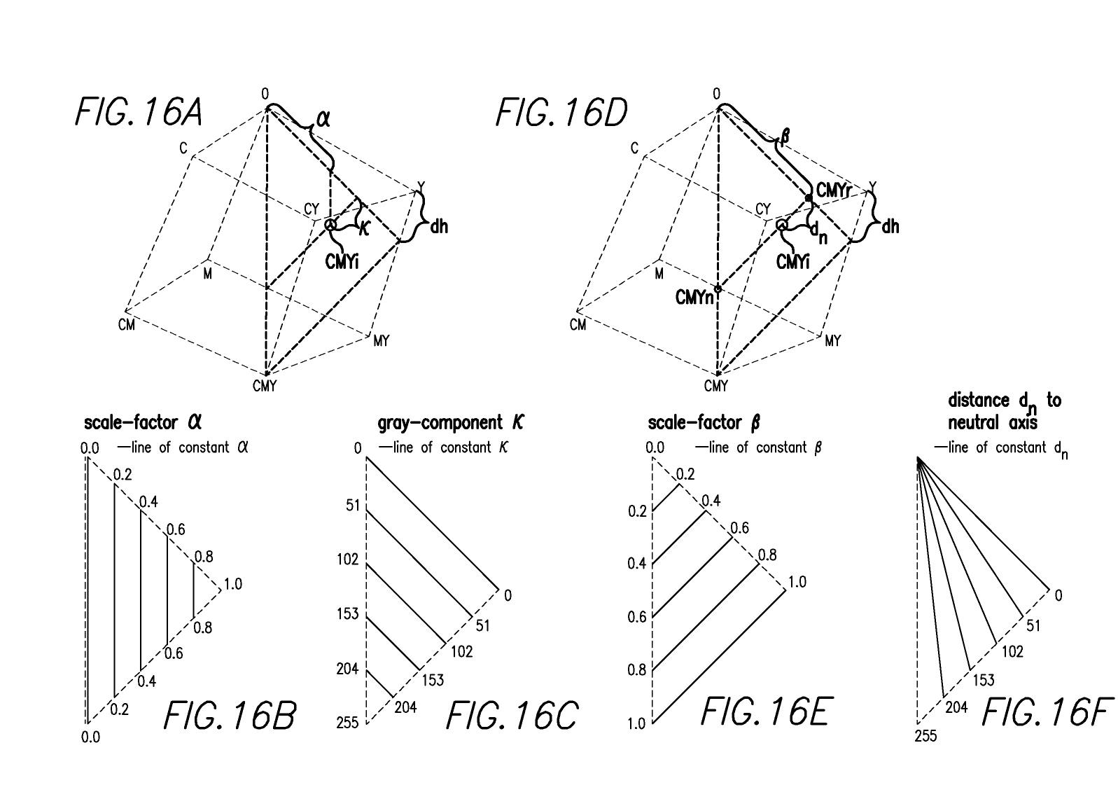

Computing optimal contone vectors for each point along the dCMY “hue ring” (FIG. 6C) then becomes a simple procedure (FIG. 6B) wherein, for each point along the “hue ring”, the hue index dh is computed that would result from presenting colors using only the CMY colorants—and this hue index is used for accessing the hue-to-contone-vector LUT computed from the theoretical gamut (FIG. 6A). This approach results in a large and nearly convex gamut, complementing the small and concave gamut obtained with the triangular-profile contone vectors.

TRANSFORM-BLENDING SOLUTION FOR A GAMUT LIMITATION—There remain, however, two serious limitations in the results described to this point. The first of these is poor homogeneity inside the color gamut (FIG. 7). Large gaps 51, 52, 53 appear in the gamut, at hues near those of the RGB inks (i. e. the additive primaries). This inhomogeneity has been traced to the divergent hue change resulting from scaling the cusp contone color vectors.

The previously considered set of contone vectors, found rather intuitively as triangular contone profiles (FIG. 3A), do scale well and produce no such gaps. As will be recalled, they produce a small color gamut with concavities.

Thus the cusp-generated vectors and the triangular-profile vectors have complementary properties. Their complementarity can be resolved by using a triangular-vector LUT in the interior of the gamut—and a transition to the gamutmaximizing cusp LUT toward the periphery (FIG. 9).

The favorable interior properties (scalability and homogeneity) are exploited in the interior; and the favorable peripheral properties (convexity and size), at the periphery. Rather than a LUT of only one contone vector per index value (as seen in the two different lines of development summarized above), the LUT in the hybrid system has two-contone vector functions (one of the triangular contone profiles, and the other of the cusp-generated contones) plus a new parameter specifically for blending or merging the two functions.

That parameter p (FIG. 8) is a ratio determined from the lightnesses J_{T} of the triangular-profile contones and J_{M} for the maximum-chroma cusp, at a single common value dh of the hue (index). Arithmetic to effect this accommodation is set forth below.

First, the blending value p is calculated as (100−J_{T})/(100−J_{M}). Second, the following algorithm is performed in lieu of the simpler one for the triangular contones. The variables defined earlier remain in use here, but in addition to the scaling constant α, a second such constant β is now introduced. To use the above hue-ring LUT, the following algorithm is performed.
1. Determine the index dh, scaling factor a and gray component κ as before.
2. Compute an additional new scaling factor β=max(dC,dM,dY)/255, i. e. the maximum of the input (rather than, as in the earlier algorithm, the maximum of the input after gray-component removal); this results in an intermediate space in which β and κ are mutually orthogonal at each value of the index dh).
3. If β is less than p, scale the triangular cusp by β/p.
4. Else if β is between p and 1, interpolate between the triangular and PSS-max. cusp
5. Scale the output of step 3 or 4 by α/β (to revert to the triangular space at each value of the index dh).
6. As before, add κ back into the CMY channels of the step-5 output.
   The result of this protocol is a gamut as large as that found earlier from the triangular-profile contones but with much improved homogeneity (FIG. 12).

A significant condition deserving attention here is that the contone vectors in the triangular and maximum-cusp LUTs be mutually aligned in terms of hue. This should be done explicitly, since the transitions between some inks are non-monotonic in hue terms.

To address this condition, we begin with setup 54 (FIG. 11) of the hue-ring LUT or algorithm as detailed elsewhere in this document. It is at this initial stage, too, that a preferred device-hue-set can be introduced for purposes of hue emulation as mentioned earlier—or, if preferred, default CMY device-hues for the apparatus actually in use can be invoked. For emulation, as noted above, system hues may be employed that are characteristic of incremental-printing, earlier traditional-printing, display, or projection systems. Further notes about the hue-emulation capability of the invention appear in a separate section later in this document.

In purest principle, preferred embodiments of the invention proceed from establishment of any coordinates along the hue ring—so that the output device-colorants are indexed by some hue coordinates. As a practical matter, however, determination or establishment of coordinates that correspond to some real input-device hue is highly desirable, so that the output device-colorants are in fact indexed by input device-hues as well.

Then based upon gray removal and a printer model 54a the device-hues 55 to be used are identified iteratively (with intervening linearization 55a). Two contone sets (triangular and maximum-cusp) are computed 56, 57 and then are hue-matched 58.

It is usually in these modules that the preferred PSS-sampling procedure operates. It will be understood, however, that such sampling and the associated gamut definition can be performed earlier and saved.

Computation 59 of the chroma ratio p concludes the hue-alignment protocol. When the entire algorithm and/or LUT is assembled and operating, triangular cusps 37 (FIG. 3A) are actually transformed, by shifting and stretching or compressing along the hue scale, to contones 65 (FIG. 12) that hue-match the corresponding maximum-cusp entries. In other words, the new contones in a sense have a hybrid hue scale. Although aligned or blended in hue (only), with the maximum-cusp contones, their magnitudes and their fundamental shapes are otherwise unchanged.

GAMUT EXTENSION TO RESOLVE A SECOND LIMITATION—As mentioned above, there is yet one further serious limitation in this form of the invention. Although it produces very good results in terms of general gamut properties—homogeneity, convexity and overall size—certain important colors are outside the system gamut.

In particular such unreachable or omitted colors include the CMY secondaries, and parts of the transitions from the CMY primaries to those secondaries. This brings the gamut up short, particularly in darker reds, greens and blues. Furthermore an increase in darker reds is highly desirable for standard gamut coverage (e. g., using ISO coated stock).

It might be supposed that these shortcomings represent errors in the protocol, since the missing colors correspond to secondaries of the input device-space, and these secondaries are specifically and precisely traversed at the alternate vertices along the very device-hue ring used to select and index the LUT or algorithm. To the contrary, exclusion of particular output device-colorant regions (even the output device-colorant primaries) arises in very subtle fashion from the ways in which the output side of the LUT or algorithm is—as noted above—“populated”.

In correcting such peculiarities it is important to resist the temptation to simply insert, by manual intervention, the excluded colorants themselves directly into the output side of the algorithm or lookup table. It is by far preferable to maintain the fully automatic character of the overall procedure, by building the automatic correction into the hue-ring populating steps.

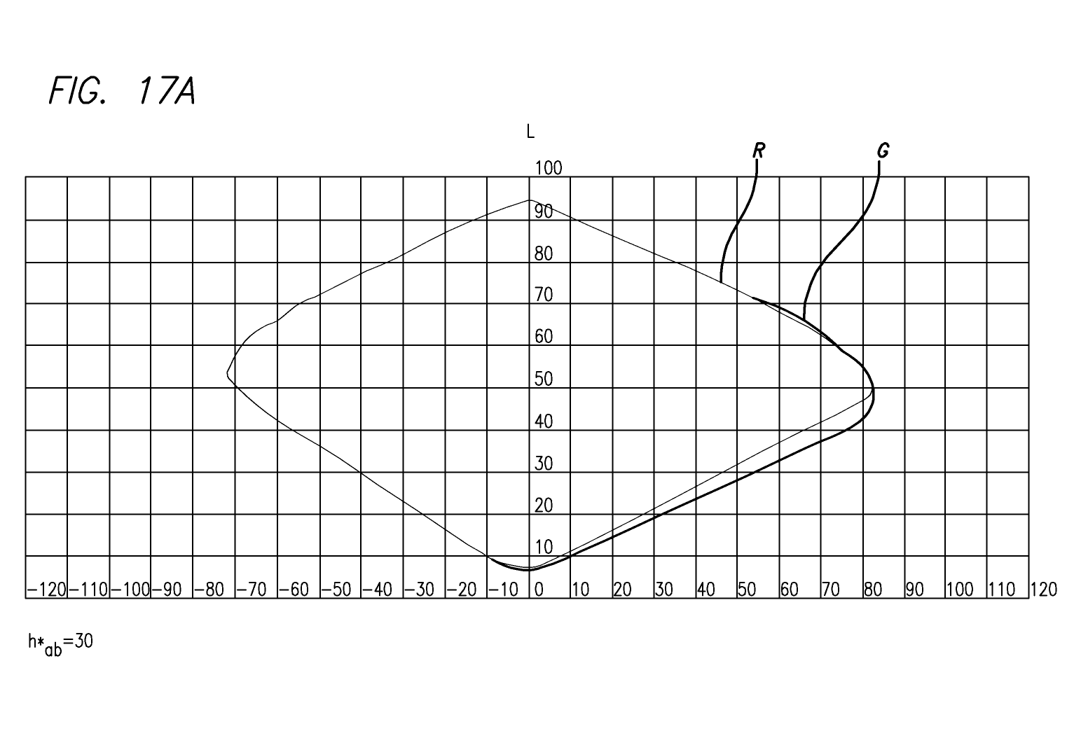

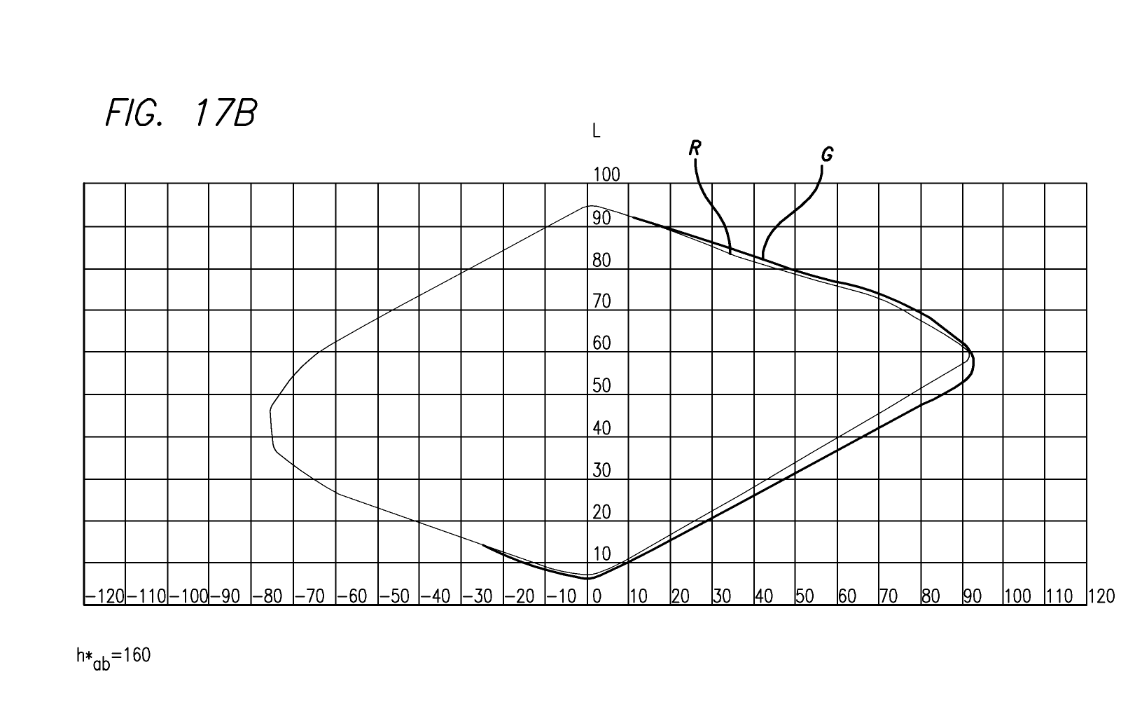

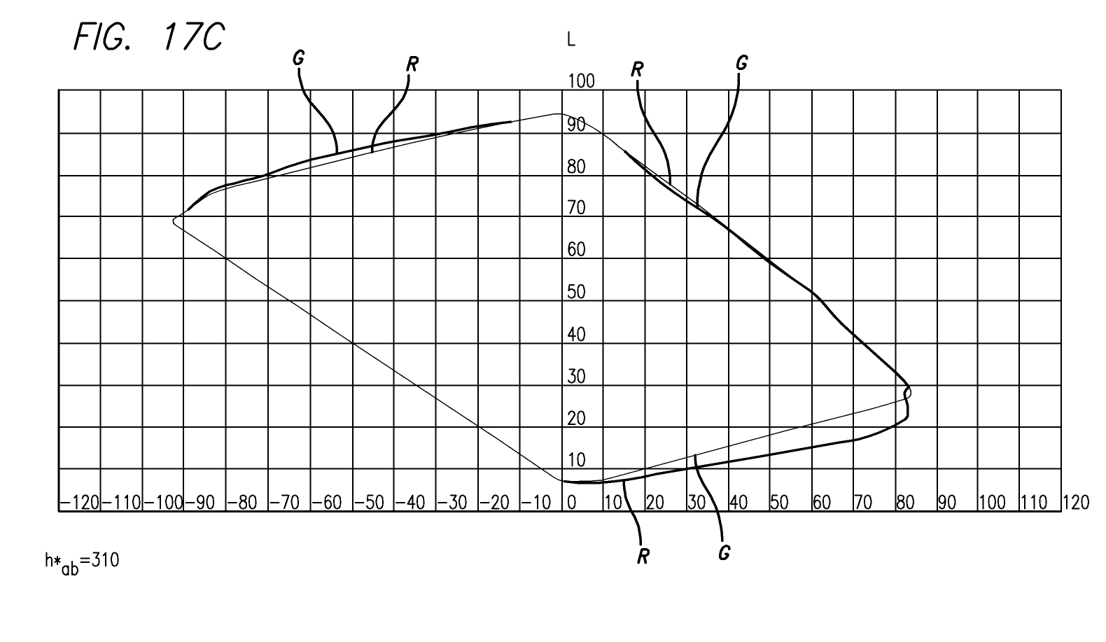

To accomplish this, an additional extension 61 (FIG. 11) of the present CCR invention, explained below, is introduced and yields a separation that includes CMY secondaries within its outputs. First, the hue-ring LUT is extended to provide these data for each index dh:
1. as before, the contone vectors of the triangular contones used for homogeneity in the interior;
2. also as before the ratio p—determined from the lightnesses of the triangular and maximum-cusp contones at the common index;
3. still further as before, the contone vector of the maximum-cusp contones, the profile giving the maximum gamut;
4. a new contone vector \vec{Γ} of the cusp-to-black (CTB) gamut (FIG. 15) that gives access to extra gamut in the cusp-to-black part of the gamut (FIG. 16), relative to the CTB lightness range interval; and
5. a corresponding new subvariable—for purposes of this document denominated [symbol] —which is the lightness of the above-introduced vector \vec{Γ} (thus the cusp has a lightness value [symbol] =0; and the dCMY=[255,255,255] point, a lightness value [symbol] =255).

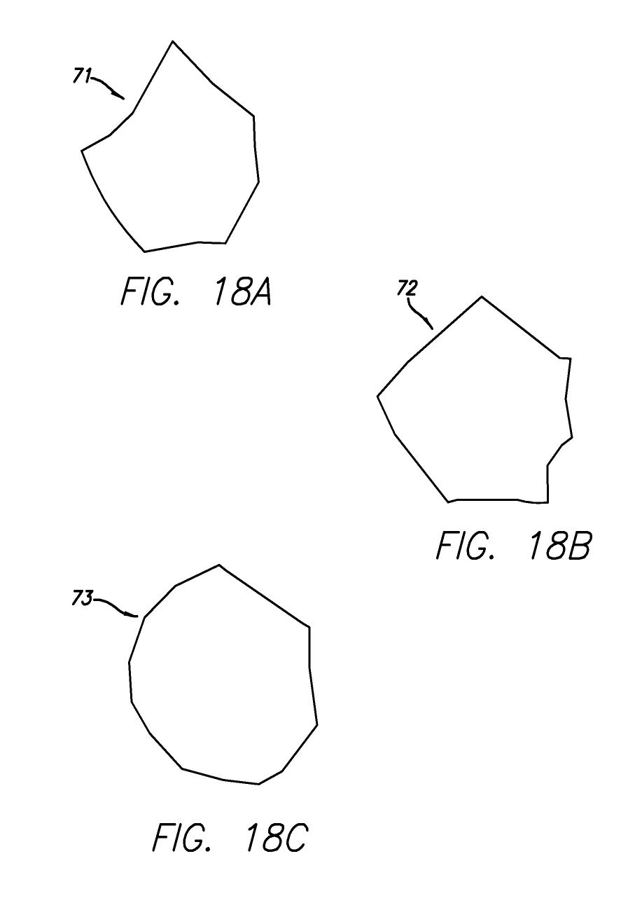

To use the above hue-ring LUT, this algorithm is performed (FIG. 17):
1. Determine the index dh, scale factors ∀ and ∃, and gray component 6 as in the first transform-blending procedure above.
2. If ∃ is less than p, scale the triangular cusp by ∃/p (i. e., again, the same as in the first blending procedure).
3. Else if ∃ is between p and 1, then instead do these substeps a through e:
   a. Compute dₙ—the normalized distance from the neutral axis, as follows (essentially, dₙ is a dimension that has a full [0,255] range at each level of ∃—except for ∃=0, where it is undefined).

$${d}_{n} = 255 \frac{‖ {CMY}_{r} - {CMY}_{i} ‖}{‖ {CMY}_{r} - {CMY}_{n} ‖} ,$$

where
CMYᵢ is the input
CMY_{c}=CMYᵢ−κ is its chromatic part (input minus gray component)
CMYₙ=[max(CMYᵢ),max(CMYᵢ),max(CMYᵢ)] is the neutral-axis point corresponding to CMYᵢ; and
CMYᵣ=CMY_{c}·s, where

$$s = \frac{max ( {CMY}_{i} )}{max ( {CMY}_{c} )} ,$$

is the top CMY surface point corresponding to the input CMYᵢ.
b. If dₙ is greater than or equal to the CTB cusp-vector lightness [symbol] , set a first approximation of an output vector \vec{O}₁ to equal the CTB cusp \vec{Γ} and subtract the CTB lightness value [symbol] from the CMY components of \vec{O}₁. (This is done because the CTB cusp is equivalent in lightness to having a CTB amount of gray component added to the PSS max. cusp. Making this subtraction effectively means that the CTB cusp will substitute the gray component in the [0,CTB] range and that the gray component will be ramped up from CTB onward.)
c. Else, obtain \vec{O}₁ by interpolating between the CTB and PSS max. cusp vectors depending on where dₙ is in the interval [0,CTB].
d. If α is in the interval [p, 1]—i. e., if triangular and PSS maximum cusps do not coincide—interpolate between \vec{O}₁ and the triangular cusp based on the value β in the interval [p, 1] to yield a final output.
e. Else, the final output is \vec{O}₁.
4. Scale the output of step 2 or 3 by α/β (to revert back to the triangular space at each dh).
5. Add κ to CMY channels of the step-4 output.
6. As before, for completion 62 (FIG. 11) of the separation the transforms (now all three) are blended and the previously removed gray component replaced.

People skilled in this field will appreciate that the modules shown (FIGS. 1 and 11) and discussed represent both apparatus and method aspects of the invention.

An essential part of this solution is the way that the CTB cusp contones \vec{Γ} are computed, and many solutions that are initially intuitive do not work satisfactorily. As a matter of enabling good practice of the invention, in its best mode, we shall therefore consider what CTB cusp contones work well.

To compute CTB cusps \vec{Γ} for all values of the index dh, the following method was used.
1. Determine the values of the index dh for the CMY primaries (i. e. C, M, Y) and secondaries (i. e. CM, CY, MY) and add the PSS maximum cusp contones \vec{Γ} at those values of dh to the corresponding CMY contones. (The results are contone vectors of value zero for all inks except for a pair from CMY and a single one from RGB—e. g. zeroes at YRG).
2. Compute the LAB values of the six points from step 1 and assign to them values of index dh that correspond to their hues.
3. For each index value dh do these substeps:
   a. Find the pair of index values dh from step 2 that most closely surround it (taking care of the fact that the last index value is followed by the first).
   b. Compute the correct amount of the CMY ink that is present only in one of the two contones found in step 2a so as to match the hue of the given index value dh.
4. Compute the LABs of the contones determined in step 3, and—if their lightnesses exceed the lightness of the corresponding PSS maximum cusp—replace the output of step 3 by the latter.
5. Smooth the result of step 4 in the same way as the PSS maximum cusp contones are smoothed.
6. Compute the LABs of the smoothed contones from step 5 and from them the CTB value [symbol] for each index value dh. A value [symbol] s determined by the lightness of the CTB cusp contone, relative to the cusp-to-black lightness range interval at the given index dh (where the cusp has a CTB value [symbol] of 0 and the dCMY=[255,255,255] point has a value of 255).
   This CTB cusp computation of the CTB cusp addresses certain transitions at the bottom surface of the CMY cube (the three faces that have dCMY=[255,255,255] as one vertex), between the PSS maximum cusp and another set of contones. The latter are the sum of the PSS maximum contone and the CMYs of the CMY hue-ring. The subject transitions involve maintaining the PSS maximum cusp while ramping up CMY hue-ring contones.

Accordingly, using the algorithm extension described here gives access to extra gamut in these parts of color space: dark greens, blues and reds (FIG. 18). That is the goal for the algorithm.

In gamut-volume terms, the change of separation gives access to an extra 22,000 cubic LAB units. While this is not a huge volume increment, it appears in parts of color space where the increase is important.

Finally, the reason for applying smoothing in this solution is that the separation otherwise results in objectionable transitions, when used for printing.

OTHER CANDIDATE TECHNIQUES FOR RESTORING SECONDARIES—The foregoing preferred solution may appear unduly elaborate. Certain other candidate approaches, though seemingly more straightforward, do not work.

One of these is a transition between the PSS maximum cusp and the CMY hue-ring cusps—as the former gives maximum gamut in a*b* and the latter gives colors outside the gamut of the transform-blending method introduced earlier. This relatively simple transition approach is appealing because, among other reasons, it is closely analogous in procedure to the transform-blending method itself, i. e., they both involve transitions between different transformations or models.

This transition between PSS maximum and CMY hue-ring cusps, however, involves interpolation between two contones that use very different ink combinations, and such interpolation tends to yield abrupt or discontinuous transitions in printed colorimetry. Prints obtained from this calculation are very far from a line, in a color-appearance space, that connects the endpoints. For example one such transition results in very uneven lightness change, which is highly undesirable.

Another candidate approach is to compute the CTB cusps in an unconstrained way. This can be done by first computing a blended-transform separation as before, then predicting its gamut with the printer model used in the PSS-cusp computation, and finally going through a PSS sampling again and picking that contone vector at each hue which results in a color farthest outside the blended-transform gamut.

This does also result in a gamut increase, but fails to give access to the CMY secondaries—because the printer model sees other contones as being still-farther out-of-gamut. A further limitation with this approach is that it gives a set of CTB contones that is very rough—in turn also degrading the smoothness in transitions generated using this separation.

MAXIMUM-CUSP METHOD FOR FITTING COLORANTS TO THE HUE RING—This section discusses details of computing the “cusps” of output device-colorant theoretical color gamut. The cusp of a color gamut at a given hue angle, as noted earlier, is the color that has the greatest chroma.

The cusp data in turn can be used to control the behavior of the multicolor-separation method and apparatus discussed above. What will be described in the following subsections are: 1) a framework for computing theoretical color gamuts of printing systems, 2) techniques for smoothing the cusps' contone ink vectors, 3) a constrained cusp extraction for improved applicability to multicolor separation, and 4) integration of cusps with the rest of the present CCR invention.

1) COMPUTING GAMUTS—A first step in computing the gamut of an n-colorant (that is, n-dimensional or “nD”) printing system is to sample all the possible contone vectors that can be inputs to it. While this can be done in an exhaustive way when the number of colorants is small (i. e. around four), it becomes impractical when more colorants are used.

For example, to sample an eight-ink system exhaustively with twenty samples per ink channel would take four days to compute. With more inks or samples per ink channel, computation times soon turn into centuries. We have developed a fast sampling technique—so-called “paired-surface sequential” (PSS) sampling—especially for high-dimensional colorant spaces.

Our PSS approach, detailed in a following section of this document, yields results virtually identical (and in some cases superior) to exhaustive sampling. It completes, however, in under one second for the same eight-ink, twenty-sample-per-channel setup mentioned above.

Once samples of the entire nD contone space are available, they are used as inputs to a printer model (or other colorant-presentation-device model) that predicts spectral reflectance for each contone vector. These predictions depend on measurements of prints (or other colorant presentations) resulting from specific input contone vectors and the assumptions a given model makes about how the colorants of a color-presentation system interact. For the printer environment we have used three models, in conjunction with an eight-ink testbed:
a) Single-Constant Kubelka-Munk (Kubelka and Munk 1931; Sinclair 1997)
   This model only requires measurements of individual inks and of the blank media but optionally can use ramps to improve performance.

Therefore the total number of measurements m=n+1, or m=nr. Here n is the number of colorants and r, the number of steps per colorant ramp. We have used r=25 (i. e., 25-step ramps), giving a total of m=7·25=175 measurements to model the use of seven inks. This model effectively assumes a physical, homogeneous mixing of inks (and media) and is widely used in the paint and surface-color industries for recipe prediction. As to predicting inkjet printing it can provide good estimates of hue but tends to overpredict chroma for superposing two or more inks.
b) Classical Spectral Neugebauer (Neugebauer 1937; Shaw 2003)
   This model requires measurements of overprints of the inks, called the “Neugebauer primaries”; there are 2ⁿ of them. Optionally, as in the first model, measurements of the ramps can be added. The total number of measurements we have used for seven inks is m=2⁷+7·24=296. (The change from 25 to 24, even though r=25 here, accommodates inclusion of the inks at maximum contone value in both the ramps and the Neugebauer primaries). In its simplest form this model assumes linearity (or more accurately n-linearity) of spectral reflectance versus ink (or Neugebauer primary) area coverage. Having measurements of the ramps allows for a correction of nonlinearity. The model makes no assumptions about ink overprinting and behavior, as it has measurements for these; it is thus a flexible model that can handle a variety of ink and ink-media interactions. It can provide high accuracy, especially with its more-advanced extensions (YN correction, cellular subdivision, etc.).
c) Additive.
   Measurements required are the same as in the Kubelka-Munk model; however, this is a model of printing inks side-by-side—i. e. without overlap or ink mixing. Colors of the resulting gamut are obtained by spatial integration of differently inked parts of a unit area. Hence here the total area coverage has a maximum of 100%; any one location on the print uses at most one ink. In this context color predictions are weighted averages of the individual inks, weighted by area coverage. The additive model can provide high accuracy, especially if ramps are used for linearization.

Next, as mentioned earlier, a set of color-matching functions and a color-appearance model (e. g. CIELAB, CIECAM02) are used for predicting perceptual color appearance (lightness, chroma and hue) of each of the samples for given viewing conditions. Here graphic-arts standard conditions (ISO, 2000) are used: D50, 2° observer, 2000 lux illuminance, gray background, etc.

Finally the color appearances of the samples are used as inputs to a gamut boundary-description algorithm to obtain the theoretical gamut of the printing system. It is advisable here to use an algorithm that allows for the encoding of gamut boundary concavities. Techniques that provide this functionality include alpha shapes (Cholewo and Love 1999) and segment maxima (Morovic and Luo 2001) but, as the name suggests, not convex-hull approaches. Here the segment-maxima technique will be used.

A key requirement for the method described below is to keep track of which contone vector has resulted in a given color appearance throughout the gamut computation process. Hence the result of using the gamut boundary description algorithm are a number of gamut boundary points with known color appearance as well as contone vectors that resulted in them.

The CIELAB gamut boundary profiles (FIG. 18), were computed for a given set of seven inks (CMYKRGB) and for each of the three printer models described in this document: additive 71, Kubelka-Munk 72, and Neugebauer 73. They reveal quite different theoretical potential for the different ways in which inks are combined, under the different assumptions of the three models respectively. These silhouetted projections 71-73 of color gamuts onto the a*b* plane show the colors at the gamut boundary in this plane; these are the cusps.

In addition to these cusps it is also possible to simply compute a gamut's cusps at much higher resolution than the overall gamut computation, without increasing computation time. This can be achieved using the segment-maxima approach whereby color appearances of the samples are evaluated not only in three dimensions at some resolution (e. g. 16 hue segments) but subsequently also in two dimensions at a significantly higher resolution (e. g. 100 hue segments). This approach can yield higher-resolution a*b* gamut boundaries for the models used.

Other ways of appreciating the same point, include e. g. considering not the a*b* coordinates of the cusps but the contone values for each of the seven members of the contone vector (CMYKRGB) for each cusp. Such analysis can reveal somewhat interesting implications of model assumptions. For example, CMY are used more in the Neugebauer case; RGB, in additive side-by-side printing. Individual inks are not necessarily more chromatic on their own than when mixed with others in the Kubelka-Munk case, etc.; and contone values do not change smoothly with hue.

All such results are noisy. One reason is that, from among the various combinations of contone vector values, the one chosen for each hue interval depends purely on the chromas that the printer model predicts. Even very small shifts in chroma result in a change of choice.

The above details may help to visualize combining of inks to obtain the most-chromatic colors at each hue, but are not a viable basis for populating multi-color separation look-up tables. Encoding such noisy data in coarser LUTs would result in erratic downsampling performance.

Moreover, other constraints may be desirable beyond the simple achievement of maximum chroma. For instance, even if chroma of a yellow ink can be increased by adding a small amount of green, that may not be desirable as the green dot would likely be visible.

In view of such considerations, we prefer to smooth the curves in this way:
a) Remove “blips”—Here we refer to isolated single points where the direction of contone value changes as a function of hue angle. These points are set to the mean of their neighbors.
b) Remove small nonzero regions—If contone values are nonzero only in a small hue region, set them to zero.
d) Make contone values convex in continuous nonzero regions. That is, repeatedly set a point to the mean of its neighbors if the point is below the mean and the neighborhood does not include zero.

At the end of each of these smoothing steps the smoothed contone vectors are used to recompute corresponding color appearance. Following the above strategies automatically, by programming the criteria and smoothing steps just stated, yields new contone results that are virtually indistinguishable from the corresponding color gamut predicted using the printer model.

In addition to smoothing, it is also advantageous to impose constraints on the cusp contone vectors. Perhaps the simplest such constraint is to enforce the use of each ink on its own at the hue angle of that ink. This is done by first computing and smoothing the cusp contone vectors, and then setting the other vector members to zero for the cusps that are at the hues of the inks, respectively. Finally the result is smoothed again.

A further constraint can be used for the additive and Neugebauer models: requiring that only a pair of inks be used at any one hue, and that those two be the inks that most closely bracket the given hue—i. e. have the closest greater and smaller hues to the given one. Cusps computed using the additive model exhibit this behavior inherently, and it can be forced in the Neugebauer case to avoid using e. g. C and M at either side of the blue-ink hue. In effect this constraint asks specifically how to combine given inks for maximum chroma at given hue, rather than the more general question of what inks to use (and how) to get such chroma.

Results of this constraint in the Neugebauer case do include some gamut reduction around magenta, and to a much lesser extent reduction around red—as far as model predictions are concerned. All these models, however, are only approximations of what happens in a real printer.

While maximum-cusp computation is interesting in itself, particular benefits accrue from using it to constrain a color-separation algorithm such as the hue-parametrized technique introduced above. As indicated previously, computing optimal contone vectors for each coordinate along a dCMY hue ring then becomes a simple procedure: the device-hue dh is computed that would result from printing that hue coordinate using only a particular CMY ink-set. This device-hue can be used to access a hue-to-contone vector LUT, or fast algorithm.

An alternative is to use an output ICC profile for computing the hue angle corresponding to dCMY hue-ring points, and then use that angle to look up contone values. While this yields the same gamut as the above method (since the same contone vectors are used), simply changing the separation can drive the output from a dCMY (or dCMYK) input to hue-match an arbitrary reference, e. g. SWOP, Euroscale, or ISO coated.

Thus, using three diverse types of hue-ring LUTs produces three distinctly different printed and measured gamuts. As suggested earlier, in such a system a default CCR model produces a gamut with dramatic concavities. Even a very inaccurate model (Kubelka-Munk) of the printer reduces concavity significantly, and a more accurate model (Neugebauer) gives access to a significantly increased gamut.

All these gamut differences result simply from populating the hue-ring LUT in different ways. Dramatic benefits derive from the technique described, as compared with default color separations; and higher printer-model accuracy also improves color gamut.

To summarize the maximum-cusp details of this document: knowledge of the theoretical gamut in a printing system can be applied with major benefits to multicolor separation. A robust and fully automatic process can be followed to obtain a significantly larger color gamut when the color separation is programmed on the basis of print measurements, printer modeling, color-appearance modeling and an efficient n-dimensional gamut-sampling technique.

Here is a listing of some helpful references related to the maximum-cusp computation:
1 Cholewo T. J. and Love S. (1999) Gamut Boundary Determination Using Alpha-Shapes, Proceedings of 7^{th} IS&T/SID Color Imaging Conference, 200-204
2 ISO (2000) 3664:2000. Viewing conditions—Prints, transparencies and substrates for graphic arts technology and photography.
3 Kubelka P. and Munk F. (1931) “Ein Beitrag zur Optik der Farbanstriche”, Zeitschrift für technische Physik, Germany, 12:593-601
4 Morovic J. and Luo M. R. (2000) “Calculating Medium and Image Gamut Boundaries for Gamut Mapping”, Color Research and Application, 25:394-401.
5 Neugebauer H. E. J. (1937) “Die theoretischen Grundlagen des Mehrfarbenbuchdrucks”, Zeitschrift für wissenschaftliche Photographie, Germany, 36/4:73-89.
6 Shaw M., Sharma G., Bala R. and Dalal E. N. (2003) “Color Printer Characterization Adjustment for Different Substrates”, Color Research and Application, 454-467.
7 Sinclair R. S. (1997) “Light, light sources and light interactions”, in Colour Physics for Industry, R. McDonald (ed.), 2^{nd} ed., Society of Dyers and Colourists, 36-38.

PAIRED-SURFACE SEQUENTIAL SAMPLING FOR OUTPUT GAMUT CANVASS—This section outlines a “PSS” sampling algorithm, which yields a relatively small number of colorant-vector samples that nevertheless representatively and accurately characterize an entire n-channel device-colorant output space (i. e. ink, toner, phosphors etc.). Based on this remarkable sampling, the gamut surface can be computed quickly and accurately in a perceptual space (e. g. CIELAB or CIECAM02).

The advantages of this algorithm are extremely important in systems with many (e. g. six or more) colorants. In such cases, exhaustive, independent sampling of all dimensions results in impractically long computation times—from days to multiple decades—where the only data available are predictions of color appearance for known inputs to the system's channels.

(In cases where a color-appearance-to-colorant-space transformation [also known as a color separation] is available, this can be used to compute the gamut more quickly. The result, however, is only the gamut of the separation, not necessarily the whole gamut that can be achieved with the chosen colorants. For the former, it is necessary to sample the colorant combinations and the PSS procedure of the present invention is very greatly preferable.)

This section describes a general approach to computing the color gamut of an n-channel system, looks at the challenges of sampling n-dimensional (nD) colorant spaces (particularly for n ∃4), introduces a new sampling algorithm and illustrates its performance (saving several orders of magnitude in computation time) as compared with exhaustive, independent sampling of all n dimensions.

Digital nD colorant spaces in general can be addressed via a finite range of input values in each of the colorant channels—e. g. in the case of eight-bit addressing, integers from 0 through 255 are available. A specific combination of input values to each channel then forms an n-dimensional vector.

For a printing system having a CMYKRGB ink-set, for example, this is a 7D vector \vec{c}=[c₁, c₂, . . . , c₇] where cᵢ is the input value to the i'th channel (i ∈ [1,n]).

To compute the color gamut of an n-channel output imaging system, this procedure can be followed:
a) Sample the nD space defined by inputs to system channels (colorants).
b) For each sample, as described earlier herein, use a computational model of the imaging system to predict color appearance obtained from application of the sample inputs to the imaging system and viewing of the system output under specific viewing conditions. For instance such a model can be, for printers, Kubelka-Munk or spectral Neugebauer, coupled with a perceptual color-appearance model, e. g. CIELAB or CIECAM02. In this process, each sampled nD device-space output colorant vector produces a respective perceptual color vector \vec{a}=[J,a,b] where J is lightness, and a and b are orthogonal equivalents of chroma and hue. At this point the entire n-dimensional output device-space is already reduced to a set of estimated perceptual color specifications.
c) Use a gamut-description algorithm to determine the gamut boundary of the whole set of color appearances obtained in step “b)”. It is essential that this gamut description refrain from assuming convexity—i. e., alpha shapes, a segment-maxima technique can be used, but not convex hulls. As noted earlier, the reason for this latter constraint is that a set of color appearances corresponding to all possible inputs to a printing system often has concavities, due to subtractive combinations of inks, nonlinearity of color appearance versus spectral power, optical dot gain effects, etc. Describing such a perceptual color set as convex identifies parts of the color space as in-gamut that cannot be matched. Mapping to those parts of the convex gamut forfeits control over the output: physically impossible colorants are specified, and an automatic rendition stage or engine then substitutes willy-nilly (i. e. arbitrarily) some unintended vector. On the other hand, as noted previously, we do favor smoothing over certain very small concavities at a suitably selected subsequent stage in the procedure—i. e., not in relation to concavity of the gamut, but rather in a very different domain, namely relating to contone values as a function of device-hue. The two are not to be confused. Smoothing at that stage avoids such adverse effects and is within preferred embodiments of the invention.
   The above process forms a geometric structure (e. g. a triangulated polyhedron, or a bilinear or spline surface) in a three-dimensional color space such as CIEL*a*b*, or CIECAM02 Jab. Thus the PSS-sampling technique addresses the problem of combinatorial explosion that threatens the first step—step “a)” above—the sampling of nD colorant space.

The simplest approach to sampling an nD colorant space is to sample each of the n dimensions independently, giving all combinations of setting each of the channels to each of k values. As an example, for k=11 the sample values would be [0%, 10%, 20%, . . . 100%]. Doing so, however, generates two problems:
a) The outcome is a staggeringly large number of samples. In general the number is kⁿ, where k is the chosen sampling granularity. If k=11 the sample population is 2.1A10⁸ for eight channels, and 3.1A10¹² for twelve. Due to these large numbers, computation takes a very long time even for moderate values of k and very rapid computers.
b) Other applications (e. g. calorimetric characterization) require even larger k values for nonconvex gamut computation; otherwise some color-space regions actually inside the color gamut can, at the end, be predicted as on the boundary. A gamut boundary computed for eight inks in CIE-CAM02, using a segment-maxima method for k—and using exhaustive sampling—exhibits pseudoconcavities: these are concavities in the gamut boundary description that do not represent concavities in the ingamut color population. Values of k high enough to avoid such artifacts typically exceed forty. An exhaustive sampling with, for example, k=60 would require computation of 1.6A10¹⁴ or 2.1A10²¹ values for eight or twelve inks respectively. The resulting estimated seven decades of computing time—for even the former of these—can be mitigated through parallel processing; however, commitment of resources for such an effort remains nearly prohibitive.

The following paired-surface sequential (PSS) sampling approach has been developed to permit, for a given k value, using significantly fewer samples—that still yield virtually the same gamut boundary as obtained by exhaustive sampling.
Step a) Equidistant channel sampling. This technique ensures that the one-dimensional sampling of individual channels is optimized for gamut computation. Instead of simple even sampling in device-colorant space, a sampling in color-appearance terms is used that has equal (Euclidean) color differences between samples. This is done for each colorant channel by computing distance along the curve in color space connecting the media (i. e. white) and the colorant at maximum input value. The curve is then sampled evenly in distance terms (i. e., a sampling analogous to the difference-preserving gamut-mapping algorithm of AutoPantone Plus). The result is n sets of k input values for each of the colorant channels—in which input values for different channels are likely to be different, respectively, but always equidistant. The effect of this sampling approach is that the colorant channels need not be linearized in appearance terms but can, for example, be linear in ink weight, and still result in good gamut surface coverage.
   Before proceeding to the remaining two steps, we pause to discuss these two corresponding properties of gamut calculation—which those remaining steps exploit:

First, the anatomy of color gamuts gives the lighter part of the gamut specifically different properties from the darker part. These two parts join along the line of the cusps (i. e. the colors at each hue that have maximum chroma). In particular the lighter part of the gamut consists of colors obtained by mixing one or two of the n colorants, since adding a third colorant would result in a color that would be lower in chroma and darkness (i. e. darker) in subtractive systems. This will be exploited in Step “b)” of PSS. (The opposite of this consideration applies to additive systems. That is, properties of the top surface in a subtractive system are the opposite of the bottom-surface properties in an additive system.)

Second, notwithstanding the n-dimensional nature of the colorant space, the gamut-boundary surface is necessarily only three-dimensional. That is true because the gamut boundary exists in three-dimensional perceptual color space. Since the boundary is three-dimensional in color-appearance terms, in principle there is a way to represent it by a 3D subspace of nD.

That is, the nD space has a 3D subspace in which the gamut can be represented and will exactly match the gamut in color-appearance space. This suggests that parts of the nD space can be discarded—without necessarily sampling the colorant space exhaustively. The question is: to what color appearance do the discardable parts map? Step “c)” of the PSS algorithm exploits this characteristic.
Step b) Exhaustive colorant pair surface sampling: Given that color gamuts have a lighter, top part and a darker, bottom part joined along the line of cusps, the top part of the gamut (in the subtractive case) can be obtained by exhaustively sampling all the 2D surfaces in colorant space defined by pair combinations of colorants. These surfaces are squares in colorant space with these vertices: media white, 100% colorant 1, 100% colorant 2 and 100% for both colorants 1 and 2. Given that the exhaustive sampling of one of these surfaces involves k² samples and for n colorants there are n(n−1)/2 pairs (i. e., for eight colorants there are 28 pair combinations; and for twelve colorants, 66), the number of samples needed for sampling the colorant pair surfaces is k² n(n−1)/2, and computing the gamut of these gives the correct result for the top part of the gamut surface. The results of this step are g colors used to describe the gamut surface of the samples generated by considering only colorant-pair surfaces. For the following step it is important to store not only the color-appearance vectors (\vec{a}) but also the colorant vectors (\vec{c}) of the g gamut boundary samples.
Step c) Sequential sampling of input values applied to top-surface colorant-space vectors. To get a correct result for the bottom part of the gamut as well as to test the hypothesis that the top surface is the result of \vec{c} vectors with up to only two nonzero values, the result of the second step can serve as a basis. This can be done by starting with the first colorant (colorant 1 of n) and setting a corresponding member of each of the g colorant vectors \vec{c}_{1,j} (j∈[1,g]) from step “b)” to each of the k sample values in turn.
This corresponds to “extruding” all g colorant vectors along the first colorant's dimension. The resulting samples are used to further refine the gamut boundary computation, giving a new set of g colorant vectors. The same process is repeated for each of colorants 2 to n in turn. In this way the colorant vectors are gradually refined, by taking each of the colorants into account in sequence. Another effect of this process is that before it starts all the gamut-boundary colorant vectors have at most two nonzero entries, and by the time colorant n−2 is sampled, entries can have nonzero values in all n channels. The gamut-boundary colors obtained after sampling the entire sequence of n inks are the final result of the computation.
Using this sampling technique, the number of samples depends on three parameters:
n, the number of colorants,
k, the number of samples per channel, and
g, the number of samples used to describe the gamut boundary.

The total number of samples is computed as follows:

$$s = \frac{n ( n - 1 )}{2} {k}^{2} ngk = {n}^{2} ( n - 1 ) {k}^{3} g / 2.$$

The ratio of the exhaustive-search sampling population, kⁿ, to this expression for s represents the computational advantage conferred by use of PSS sampling. The ratio is kⁿ/s, or:

$$\frac{{k}^{n}}{{n}^{2} ( n - 1 ) {k}^{3} g / 2} = \frac{2 {k}^{n - 3}}{{n}^{2} ( n - 1 ) g} .$$

For n=8, k=40, g=256, this advantage comes to a factor of about 1800, or very roughly 3¼ orders of magnitude.

For a higher-dimensional system with greater sampling granularity, e. g. n=12 and k=60, the advantage becomes a stunning 50 billion, i. e. approaching ten orders. Such a factor reduces nearly prohibitive centuries of computation time to seconds.

Thus, compared with exhaustive sampling, the PSS technique uses a number of samples that is very small, or infinitesimal. Even for a twelve-colorant output space and k=60 it takes only a few seconds to compute. Our next topic, then, is the accuracy of this new sampling technique.

Two noteworthy aspects of PSS are: first, dependency of results on the order in which colorants are considered—in the sequential part of the algorithm (step “c]”)—and, second, overall accuracy as compared with exhaustive sampling. As to both these concerns preferably CIECAM02 is used as the color-appearance space, the single-constant Kubelka-Munk model is used to predict printed reflectance from colorant vectors, and predictions will be for an eight-ink inkjet system using CMYKR₁R₂GB inks (i. e. two reds) on a glossy substrate. We prefer to perform the gamut boundary computations using the segment-maxima technique, with 256 gamut boundary samples. We work with differences in CIE-CAM02 Jab space, where as before a and b are orthogonal equivalents to chroma (C) and hue (h).

To test for any influence of the order in which colorants are considered by the PSS technique, the gamut boundary was computed for all permutations of the eight inks (i. e. 8!=40,320). The volumes of these more than 40,000 gamuts were compared with the volume obtained for the mean of all volumes, and it was found that their range of divergence from that mean was from −0.65% to +0.51%. In other words, on average the effect of colorant order on gamut volume was only, roughly, ±½%. For a gamut with a volume of 600,000 cubic CIECAM02 Jab units, this corresponds to ±3,000. Thus the effect of colorant order is negligible.

A key criterion for adequacy of PSS sampling is that it provide samples which result in a gamut boundary very similar to the one obtained by exhaustive sampling of all colorant-value combinations. To check this property, we computed the difference between an exhaustively computed (Gₑ) and a PSS—computed (Gₚₛₛ) gamut boundary—by taking all the gamut boundary points of Gₑ and computing the minimum color differences between them and the Gₚₛₛ boundary.

We did the same for Gₚₛₛ points relative to Gₑ—but made these color differences negative, as they represent cases in which the PSS gamut exceeds the exhaustive gamut. In such instances they are not errors of the PSS sampling but of the exhaustive technique, as mentioned above in discussion of pseudoconcavity.

The range of differences computed as just described was [−3,2] ΔE_{Jab} (i. e. Euclidean distance in CIECAM02 Jab space). In the vast majority of cases (80%) PSS was as accurate as, or more accurate than, the exhaustive computation. In only 2% of cases did the PSS boundary underpredict the exhaustive boundary by more than 1 ΔE_{Jab}.

We also checked how the exhaustive and PSS techniques compared when the number of samples per channel was the same for both. We examined the cases k=20 and k=60. Accuracy of the PSS technique was virtually the same for these cases, apparently due to the sampling approach PSS takes: it has more samples on the actual gamut boundary and therefore runs less risk of false concavities. Moreover, colorant ramps are sampled equidistantly in the color space where the gamut is computed.

These investigations confirmed that PSS gives a very accurate prediction of the printing system color gamut, virtually independent of sampling-sequence order. Even for sixty samples per channel it completes the computation in roughly 10⁻⁷ of the exhaustive-computation time, while the exhaustive computation only uses twenty samples per channel and in many cases underpredicts the gamut.

Again, paired-surface sequential sampling provides accurate predictions of n-channel output imaging systems in a matter of seconds, as compared with the days or even (in extreme cases) centuries required by exhaustive computation to reach an equivalent result. PSS advantages include accurate, nonconvex, on-the-fly n-channel gamut computation at high speed, and its results can be used in both development of multicolor separation (as it yields colorant vectors of maximum possible gamut for a colorant set) and evaluation of the output (as the gamut achievable using a separation scheme can be compared to the maximum possible gamut). To make such development and evaluation more realistic, the use of ink limits and other separation-algorithm constraints also are easily incorporated into PSS gamut computation.

HUE-EMULATION CAPABILITIES OF THE INVENTION—Introductory information concerning the hue-emulation feature has been presented earlier in this document. The current section provides additional details.

In the basic practice of this invention, as explained above, a routine step determines the hue of each entry in the LUT—making it possible to determine, in turn, which combination of available inks provides maximum saturation for the given hue. For each entry, the hue that is determined in that step may be—depending broadly on the circumstances—a real hue, or a human-perceived hue, or a hue that is measured or modeled.

By default, in practice of the invention as taught above, the hue which is used is ordinarily straightforward: it is that hue which results from the conventional dCMY input-colorant subset. In other words it is the hue that appears to our eyes, physically, when generic CMY input data are printed (or otherwise presented) employing the nominal, customary, usual input colorants (e. g. inks) of some chosen printer or other colorant-presentation device.

We need not, however, make that particular hue choice. We could for instance always use traditional offset-lithography CMY hues. These are different from, e. g., customary inkjet-printing CMY hues, and from traditional letter-press-printing hues, and again from usual rotogravure hues, and further from laser-printer hues—and still again from wax-transfer hues, dye-sublimation hues etc.

Although not at all known to the general public or even to many professionals who work daily with color printing of one kind or another, the usual inks associated with these different types of printing, respectively, each have their own characteristic and distinctive hue profiles or patterns. Such patterns typically originated many years ago and are maintained as a matter of, in some cases, tradition—and, in other cases, practical reasons related to the type of paper or other printing medium typically employed, or the lighting conditions in which the printed matter is most typically viewed, and so forth.

Many people in the industry are aware of these differences and quite sensitive to them, and are keenly and very critically interested in seeing how a particular print job will appear when printed by some particular one of these several printing technologies. Ordinarily the expected arrangements for seeing how a job will appear entail going to a printshop or office where the traditional inks of relevant type are available and actually printing the job on the corresponding kind of press, or at least a proof press loaded with the pertinent ink.

Hence a technology that enables seeing the hues for any print job without such inconvenience has significant utility and marketplace value. Exactly such value is realized in the practice of our invention—through the mere choice of a hue set that corresponds to tradition or to common trade practice for the type of printing that is of interest.

In other words, choice of hue set effectively implements offset hue simulation or emulation, in the separation LUT of our invention—i. e., entirely in device space, and not using any so-called “color profile” or printer model at run time. All that is needed is a small database representing the hues of interest, and that only at LUT-calculation time.

The literature and experience establish that hue is the most important variable in making the output of one printer look like the output of another. Therefore, if this technique were applied to all printers of, say, the inkjet type (but using different ink sets) the outputs of all those printers would effectively begin to appear like, e. g., offset-litho output (and hence like each other).

This would be accomplished, however, without giving up the native gamut of any individual printer. An odd side effect and possible drawback is that maximally saturated primaries and secondaries (using CMY terminology) would not necessarily occur where expected (viz. at so-called “pure” C, M, Y, R, G and B locations in the hue LUT) but possibly at different locations (CMY hue angles).

Hue sets that could be used include, merely by way of example, those defined in “Specifications for Web Offset Printing” (SWOP), or in “International Standards Organization offset coated” printing specification (“ISO coated”), or corresponding to a previous or otherwise different inkjet printer, or to a competitor's printer, etc. Physically, to exploit the simple emulation discussed here, it is necessary also to use a different printer model when determining the hue that corresponds to each entry of the hue LUT.

More specifically, rather than interrogating a multiink printer model based on measurement of e. g. the CMY subset of an inkjet printer that is in use, it is required instead to use a printer model based on measurements of e. g. an offset press (SWOP, ISO coated, etc. as mentioned above). Such printer models can be obtained through printing and measuring color patches in a laboratory, printshop or office, or by using data that are already available—e. g. in the form of an ICC printer profile.

In other words, it is possible to hue-emulate any printer for which an ICC profile is available. This is a very large set of printers.

When this technique is used to emulate hues, the hues are the same—but other attributes of the deposited (or otherwise presented) colorant are different. Such other attributes include other color coordinates (saturation and lightness), as well as physical characteristics such as ink usage.

Maximally saturated primaries and secondaries (in CMY terminology), or maximally saturated primaries (in CMYRGBN terminology)—actually do have expected positions (hue angles) at which to “occur” in the hue LUT. As noted earlier, these positions may be established by trade practice for practical reasons, or based merely upon custom, or in some cases combinations of these.

This document describes, in an earlier section, how the hue ring is defined. It bears repeating that there is no real hue, i. e. no perceivable hue, associated with the hue-ring features (vertices, segments, coordinates etc.) until a corresponding color has been determined (or otherwise established) for a given printer, ink, and media combination; hence the need for printer models—or equivalently many measurements.

If actual CMY inks (a subset of, say, the inkjet multicolor ink set) are used to build the LUT, the maximally saturated cyan color (as measured or perceived) occurs at the hue-ring coordinate corresponding to dCMY (100,0,0), because it has in fact been explicitly associated with CMY (100,0,0) in real ink space; and similarly for any other color. If another printer's CMY hues, instead, are used to build the LUT, the two will probably not coincide exactly, because at the cCMY (100,0,0) location in the hue ring it is now established that the system will use a multiink combination that results in another printer's CMY (100,0,0) hue. The two coincide only if exactly the same inks, papers, marking engine, etc. are used; and different C inks or other variations will result in different hues.

When maximum chroma appears at different CMY hue angles (hue-ring coordinates) from the normally established ones, as in fact occurs with the hue-emulation under discussion, curious color distortions can be noted. When a conventional, nonemulating printer is driven in dCMY, input values are mapped directly to ink percentages, and hence by definition pure dCMY coincides with pure ink CMY. A hue-emulating printer distorts this relationship by inserting a hue-emulation LUT, such that pure dCMY colors no longer coincide with pure ink CMY colors, but rather produce the hues that would result if the emulated printer were driven in an ordinary CMY mode.

Pure colors (in both dCMY and ink CMY) normally coincide with gamut cusps or places of maximum saturation (chroma) in the gamut, but now that relationship too is broken, i. e. interrupted. This can be good: for an operator who is used to SWOP hues when designing posters in CMY[K] color space, the result is close (in regard to hue) to what that person expects.

That operator/designer obtains the expected and desired output, but with a sort of bonus in the form of an extra saturation boost. On the other hand, for a person who is expecting the actual printer's purest, most chromatic color for that hue, without intruding dots of another ink color—i. e. what could be called the “best” color from that printer—there will be disappointment.

More specifically, invoking a particular cyan color by specifying (100,0,0) does not actually produce pure cyan—that color might be at (100, 5, 0) for instance. While the color obtained might be perfectly acceptable under some or many circumstances, there may be significant problems with the departure from expectations if it is not understood what has occurred.

In real physical terms, some operators, designers, printing buyers and so on can actually notice such effects. Even some individuals who are not sufficiently hue sensitive to see a slight cast—e. g. a hue that is appears slightly “off”—may be in the habit of using a magnifying glass to look for stray pixels of one color in a nearly solid field of another color. Such critical inspections may become less and less relevant as drop weight, spot size etc. decrease with advancing technology in this field; however, at present they are common.

Following is a review of the overall invention, with additional orientation to the hue-emulation aspects of the invention. As will be recalled the invention is not limited to colorant-presentation systems that use ink on paper; however, for definiteness these remarks continue to describe details for that example.

The object is to augment e. g. a CMY printer with additional primary inks such as the chromatic colors R, G, and B. Black (K) is a passthrough as far as CCR is concerned, although eventually it is strongly preferable to build complete CMY-to-CMYKRGB (and similar) mappings.

The basic CCR form of this invention uses a single hue LUT to accomplish the transformation from dCMY to dCMYRGB (more advanced forms use plural hue LUTs). To accomplish this it is necessary to, in effect, shrink the entire dCMY cubic space to a one-dimensional hue address, and for each specific address within the range look up the corresponding CMYRGB ink vector.

The next step is to effectively reinflate the one-dimensional address back into a cubic space, with that six-dimensional vector annotated at its rightful place in the cube. In this way the entire dCMY space is transformed into an equivalent dCMYRGB space with enhanced properties—such as larger gamut, less ink, etc.

This shrinking and reinflation is done by removing the gray component (as in gray-component replacement, “GCR”), scaling the remainder into the input side of the hue LUT, and scaling the looked up vector out from the output side of the hue LUT—and then adding the gray component back in, to form the proper shade or wash. The reason for these maneuvers is that the hue LUT only specifies ink combinations of maximum saturation (chroma). All others are, in effect, inferred from it through the so-called “shrinking” and “reinflation” process just described.

It remains to review the question of how to decide what to put into the hue LUT, most particularly in its output side. Even before the basic form of the invention, a rough preliminary approach (also outlined earlier) proceeded with no hue LUT; its behavior is mimicked exactly by a perfectly regular triangular separation profile.

The latter is based, as earlier passages of this document have already demonstrated, not on any modeling or measurements but simply on certain elementary default assumptions about linear ink mixing. This approach is not only theoretically appealing, but also works well in the central part of the gamut—and accordingly is partially retained, for that region, in the most advanced forms of the invention.

Elsewhere it is required to calculate hue LUTs using some actual measurements—with PSS sampling to moderate the cost of computation, and printer (color) models such as ”additive” and Neugebauer to further reduce the need for physical printouts and measurement. The process of preparing the LUT off-line (as distinguished from applying it on-line) may be seen as including these conceptual components:

Since the hue LUT is indexed by hue, the output must be determined as a function of hue.

Since the process is said to be one of augmenting a CMY system, a straightforward approach is to use the hues that would result from just CMY inks, then look for CMYRGB ink combinations that result in the same hue but other enhanced properties (more saturation, greater gamut, less ink, etc).

Hue, however, as very well known is only one of the three perceptual/-colorimetric variables that determine any perceived color; and while the invention produces output hue that is by definition the same as input hue, the other variables are not necessarily the same. Saturation, possibly lightness (and possibly other properties such as total ink usage) in general differ.

Hence for each location in the hue LUT it is necessary to determine input CMY hue by using a Neugebauer or similar printer model based on measurements of actual inks, which must always include at least CMY; and, next, to determine the output ink vector that results in the same hue (but more saturation, etc.) and store it in the hue LUT.

When that LUT is later applied in real-time operation, the hues of the CMY subsystem are maintained, but faithfully using an additional complement of inks—resulting in higher saturation, larger gamut, less ink, etc.

The hue-emulation feature is a variant of the input-CMY-hue determining step (two paragraphs above): instead of determining input hue from the CMY inks of the printer that is in use, the input hue is determined from the CMY inks in another printer (e. g. offset). The end result is once again to maintain hue relative to the other printer, while using the ink set of the printer in use—with its greater gamut and chroma etc., but also with some chroma or lightness shift.

The foregoing disclosure is intended as merely exemplary. It is not intended to constrain the scope of the present invention—which is to be determined by reference to the appended claims.

We claim:

1. A method for preparing to present specified input device-colors using an output colorant space; said method comprising the steps of:
formulating a lookup table or real-time computation algorithm, or both, to transform input device-color to an output colorant space;
wherein the formulating step comprises:
defining plural color-space transformations for use in different portions of an input device-color space, and
assembling the table or algorithm, or both, to blend the plural transformations; and
making the table or algorithm, or both, physically available in a nonvolatile medium for use in presenting the output colorant.

2. The method of claim 1, wherein:
the formulating step further comprises forming the table or algorithm, or both, to remove substantially all gray from input device colors before applying the transformations, and to replace the removed gray in the output colorant space thereafter.

3. The method of claim 1, wherein:
the plural transformations comprise at least:
a first transformation which yields an output colorant-space gamut that is relatively homogeneous internally, but relatively small and subject to concavities, and
a second transformation which yields an output colorant-space gamut that is relatively larger and with minimal or no concavities, but subject to relative internal inhomogeneity; and
the formulating step causes the table or algorithm, or both, to blend the transformations to form:
a hybrid relatively larger gamut that is relatively homogeneous internally and with minimal concavities, and
output colorant-space color specifications of the hybrid gamut.

4. The method of claim 3, wherein the formulating step further comprises:
causing the table or algorithm, or both, to step a selection protocol around a hue ring of the input device-color space, to successively select device-color hues of that space;
aligning the first and second transformations, and thereby the output color specifications, with respect to hue; and
for each of said selected device-hues, processing the hue-aligned output color specifications to form a transformed color in output colorant space.

5. The method of claim 4, wherein the formulating step:
establishes one of said transformations by locating a color of substantially maximum chroma for each hue along the hue ring, respectively; and
further comprises indexing said maximum-chroma colors by hue, to access the table or algorithm, or both.

6. The method of claim 3, wherein:
said relatively larger gamut, established by said first and second transformations, encompasses little or no output device-space volume surrounding at least one specific secondary color; but
the plural transformations further comprise at least a third transformation which yields an output colorant-space gamut addition encompassing output device-space volume that includes said at least one specific color; and
the table or algorithm, or both, blend at least all three transformations to provide a relatively larger gamut that is substantially homogeneous internally and with minimal concavities, and encompassing output device-space volume that includes the at least one specific color.

7. The method of claim 6, wherein:
the formulating step establishes said third transformation by expanding the overall gamut toward darker colors, and toward the at least one specific color, based upon a normalized distance, in input device-space, between the input device-colors and the neutral axis.

8. The method of claim 1, further including the steps of, with respect to at least multiple pixels in an image:
directing input device-space color specifications as inputs to the table or algorithm, or both;
reading output colorant-space values as outputs from the table or algorithm, or both; and
applying the output colorant-space values to rendition and other presentation-engine makeready stages, for presenting the colors.

9. A system for presenting input device-colors using an output colorant space; said system comprising:
a color presentation engine;
a driver including a lookup table or real-time computation algorithm to transform input device-color to an output colorant space;
said table or algorithm, or both, having been formulated by a process comprising the step of defining plural color transformations for use in different portions of the input device-color space, and the step of assembling the table or algorithm, or both, to blend the plural transformations;
means for directing input device-color specifications as inputs to the table or algorithm, or both; and
means for applying blended-transformation output colorant-space values from the table or algorithm, or both, via rendition and other makeready stages, to the presentation engine.

10. The system of claim 9:
the table or algorithm, or both, having been formulated by said process that further comprises the step of removing substantially all gray from input device-colors before applying the transformations, and replacing the removed gray in the output colorant space thereafter.

11. The system of claim 9, wherein the plural transformations comprise at least:
two transformations which respectively yield output colorant-space gamuts that have respective colorimetric deficiencies; and
wherein the formulating step causes the table or algorithm, or both, to blend the transformations to provide a single output colorant-space gamut that is substantially free of the deficiencies.

12. The system of claim 9, wherein the plural transformations comprise at least:
a first transformation which yields an output colorant-space gamut that is substantially homogeneous internally, but relatively small and subject to concavities; and
a second transformation which yields an output colorant-space gamut that is relatively larger and with minimal or no concavities, but subject to relative internal inhomogeneity;
wherein the formulating step causes the table or algorithm, or both, to blend the transformations to provide a relatively larger gamut that is substantially homogeneous internally and with minimal concavities.

13. A method of presenting input device-colors, but using output device-colorants; said method comprising:
performance, or an abbreviated procedure yielding the same results as performance, of these steps:
establishing coordinates along a hue ring, and
with each said coordinate, associating a respective output device-colorant specification,
whereby the associated output device-colorants are indexed by said
hue-ring coordinates, for subsequent use in a transformation that maps said coordinates to corresponding output device-colorant specification; and
presenting colors based upon the indexed output device-colorants.

14. The method of claim 13:
further comprising the step of, at each coordinate, determining or establishing a respective input device-hue;
whereby the associated output device-colorants are indexed by said input device-hues, too, for said subsequent use.

15. The method of claim 14, wherein:
the associating step comprises associating an output device-colorant that has maximum chroma at the determined or established input device-hue.

16. The method of claim 14, wherein:
said input device-hues are native to a color-presentation device that said transformation, with said presenting step, thereby emulates.

17. The method of claim 16, wherein the input device-hues are selected from the group consisting of:
incremental-printing device-hues, including but not limited to inkjet, bubble-jet, wax-transfer, and laser-printer colorant spaces;
offset-lithographic, gravure, or flexographic printing device-hues;
display device-hues, including but not limited to those used in computer monitors, television sets and other video screens; and
projection device-hues, including but not limited to those used in laser- and conventional arc-lamp-projection technologies.

18. The method of claim 13, wherein said steps further comprise defining a gamut boundary of the output device-colorants, by the steps of:
choosing contone vectors representative of substantially all the output device-colorants, as used throughout their colorant space;
operating a presenter model to calculate reflectance spectra of all the chosen vectors;
operating a perceptual color model to calculate perceptual parameters, from the spectra, for all the chosen vectors; and
operating a gamut boundary description algorithm to define, from the perceptual parameters, the output-space gamut boundary.

19. The method of claim 18, wherein:
the choosing step comprises paired-surface sequential sampling; and
the paired-surface sequential sampling is used to establish colors substantially throughout the entire output colorant space, particularly including dark colors below the cusps of the output-space gamut.

20. The method of claim 13, wherein:
the abbreviated procedure comprises referring to a lookup table previously formulated, by said stops, to yield said same results.
